(19) United States
(12) Patent Application Publication
(10) Pub. No.: US 2017/0146124 A1
(43) Pub. Date: May 25, 2017

(54) Cover for an Access Opening

(71) Applicants: Franco F. Daino, Muskego, WI (US); Matthew T. Dudgeon, Whitefisn, WI (US); Todd Grover, Oak Creek, WI (US); Mark Rodaer, Wauwatosa, WI (US); Scott B. Stevens, St. Francis, WI (US); Master Lock Company LLC, Oak Creek, WI (US)

(72) Inventors: Franco F. DAINO, Muskego, WI (US); Matthew T. DUDGEON, Whitefish Bay, WI (US); Todd GROVER, Oak Creek, WI (US); Mark RODAER, Wauwatosa, WI (US); Scott B. STEVENS, St. Francis, WI (US)

(73) Assignee: MASTER LOCK COMPANY LLC, Oak Creek, WI (US)

(21) Appl. No.: 15/304,551

(22) PCT Filed: Apr. 17, 2015
(86) PCT No.: PCT/US2015/026313

§ 371 Date: Nov. 9, 2016

Related U.S. Application Data
(60) Provisional application No. 61/981,233, filed on Apr. 18, 2014.

(51) Int. Cl. F16J 13/02; F16J 13/24; E05B 65/00; E06B 9/06; E06B 5/10

(52) U.S. Cl. CPC F16J 13/02; E06B 9/0692; E06B 5/10; E05B 65/006; F16J 13/24

(57) ABSTRACT

A cover assembly for restricting access to an access opening includes a cover member and a flexible member. The cover member includes a central covering portion surrounded by an outer peripheral collar portion defining a passage, and a tab affixed to the collar portion, with the tab including at least one tab aperture. The flexible member extends through the passage and has a first end extending outward of the passage and including at least one flexible member aperture, and a second end secured to the collar portion. When the first end of the flexible member is pulled, the collar portion of the cover member is constricted, and one of the at least one flexible member apertures is aligned with one of the at least one tab apertures to receive a locking member therethrough, thereby securing the collar portion in a constricted condition.

### CROSS-REFERENCE TO RELATED APPLICATION

This application claims the benefit of U.S. Provisional Patent Application Ser. No. 61/981,233, entitled “COVER FOR AN ACCESS OPENING” and filed Apr. 18, 2014, the entire contents of which are incorporated herein by reference, to the extent that they are not conflicting with the present application.

### BACKGROUND

Manways and other access openings to hazardous and potentially hazardous confined workspaces may present risks of injury or fatality when accessed by unauthorized or improperly equipped individuals, or under temporary or permanent unsafe conditions. OSHA's standards for hazardous and potentially hazardous confined spaces not only require that employers inform exposed employees of the existence, location, and hazards of these confined spaces, but also that effective measures be taken to prevent unauthorized employees from entering and working in these spaces, such as temporary barriers blocking egress through the access opening.

### SUMMARY

The present application contemplates cover assemblies for selectively blocking or restricting access to an access opening, for example, to prevent use of, access to, or entry through the access opening. The cover assemblies may, but need not, be configured to be locked out to prevent unauthorized removal of the cover assembly from the access opening.

According to an exemplary embodiment of the present application, a cover assembly for restricting access to an access opening includes a cover member and a flexible member. The cover member includes a central covering portion surrounded by an outer peripheral collar portion defining a passage, and a tab affixed to the collar portion, with the tab including at least one tab aperture. The flexible member extends through the passage and has a first end extending outward of the passage and including at least one flexible member aperture, and a second end secured to the collar portion. When the first end of the flexible member is pulled, the collar portion of the cover member is constricted, and one of the at least one flexible member apertures is aligned with one of the at least one tab apertures to receive a locking member therethrough, thereby securing the collar portion in a constricted condition.

According to another exemplary embodiment of the present application, a method of restricting access to an access opening surrounded by a flange is contemplated. In an exemplary method, a cover member is placed over the access opening, such that a central covering portion of the cover member covers the access opening, and an outer peripheral collar portion of the cover member extends over the flange. A first end of a flexible member extending outward of a passage in the collar portion is pulled to constrict the collar portion against the flange, the flexible member having a second end secured to the collar portion. An aperture in the first end of the flexible member is aligned with an aperture in a tab affixed to the collar portion. A locking member is inserted through the aligned apertures to secure the collar portion in a constricted condition.

According to another exemplary embodiment of the present application, a cover assembly for restricting access to an access opening includes a cover member and a flexible member. The cover member includes a central covering portion surrounded by an outer peripheral collar portion defining a passage. The flexible member extends through the passage and has first and second ends extending outward of the passage through first and second openings in the collar portion. The first end of the flexible member includes at least one flexible member aperture, and the second end of the flexible member includes a buckle portion having a tine with a lock aperture therethrough. When the first end of the flexible member is pulled and the tine is inserted through one of the at least one flexible member apertures, the collar portion of the cover member is constricted, such that insertion of a locking member through the lock aperture secures the collar portion in a constricted condition.

According to another exemplary embodiment of the present application, a method of restricting access to an access opening surrounded by a flange is contemplated. In the exemplary method, a cover member is placed over the access opening, such that a central covering portion of the cover member covers the access opening, and an outer peripheral collar portion of the cover member extends over the flange. First and second ends of a flexible member extending outward of a passage in the collar portion are pulled to constrict the collar portion against the flange. A cinching mechanism assembled with the first end of the flexible member is operated to cinch against the second end of the flexible member, thereby securing the collar portion in a constricted condition.

According to another exemplary embodiment of the present application, a cover assembly for restricting access to an access opening includes a cover member having a central covering portion surrounded by an outer peripheral collar portion, and at least one strap securable to first and second opposed portions of the collar portion. When the collar portion of the cover member is installed over an outer flange portion of a flanged access opening, the at least one strap is adjustable to secure the cover member to the flanged access opening.

According to another exemplary embodiment of the present application, a method of restricting access to an access opening surrounded by a flange is contemplated. In the exemplary method, a cover member is placed over the access opening, such that a central covering portion of the cover member covers the access opening and a collar portion aligns with an outer flange portion of the access opening. At least one strap is secured to first and second opposed portions of the collar portion. The at least one strap is adjusted to secure the cover member to the flanged access opening.

According to another exemplary embodiment of the present application, a cover assembly for restricting access to an access opening having an end portion includes a cover member including a central covering portion and a plurality of rigid arms assembled with the cover member. The plurality of rigid arms are adjustable between a lockout position for engagement with the end portion and a release position for disengagement from the end portion.

According to another exemplary embodiment of the present application, a method of restricting access to an access opening having an end portion is contemplated. In the exemplary method, a cover member is placed over the access opening, such that a central covering portion of the cover member covers the access opening. A plurality of rigid arms assembled with the cover member are adjusted from a releasing position in which the plurality of rigid arms are disengaged from the end portion of the access opening to a lockout position in which the plurality of rigid arms are engaged with the end portion of the access opening to secure the cover member to the access opening.

According to another exemplary embodiment of the present application, a method of restricting access to an access opening is contemplated, with the access opening having an end portion with a first diameter and an inner portion with a second diameter greater than the first diameter, with the inner portion being separated from the end portion by a shoulder. In the exemplary method, a frame member is inserted into the inner portion of the access opening, with the frame member having first and second laterally extending arms together defining a length greater than the first diameter, and at least one stem extending transverse to the first and second arms. The frame member is oriented so the at least one stem extends toward the end portion of the access opening. A cover member is placed over the access opening, such that a central covering portion of the cover member covers the access opening. The cover member is secured to the at least one stem.

According to another exemplary embodiment of the present application, a cover assembly for restricting access to a flanged access opening including a flange having a ring of mounting holes includes a cover member having a central covering portion, and a plurality of rigid arms assembled with the cover member. Each of the plurality of rigid arms is adjustable to align at least one mounting aperture on the rigid arm with a corresponding mounting hole of the flanged access opening for mounting the plurality of rigid arms to the flange.

According to another exemplary embodiment of the present application, a method for restricting access to a flanged access opening including a flange having a ring of mounting holes is contemplated. In the exemplary method, a cover member is placed over the access opening, such that a central covering portion of the cover member covers the access opening. A plurality of rigid arms assembled with the cover member are adjusted such that a mounting aperture on each of the plurality of rigid arms aligns with a corresponding one of the mounting holes in the flange. A fastener is installed through each of the aligned mounting apertures and mounting holes to secure the cover member over the access opening.

### BRIEF DESCRIPTION OF THE DRAWINGS

Further features and advantages of the invention will become apparent from the following detailed description made with reference to the accompanying drawings, wherein:

FIG. 1 is a perspective view of a cover assembly in accordance with an exemplary embodiment;

FIG. 2 is a perspective view of the cover assembly of FIG. 1, shown partially assembled with a flanged access opening;

FIG. 3 is a perspective view of the cover assembly of FIG. 1, shown fully assembled with a flanged access opening;

FIG. 4 is a perspective view of a cover assembly in accordance with an exemplary embodiment;

FIG. 5 is a perspective view of the cover assembly of FIG. 4, shown partially assembled with a flanged access opening;

FIG. 6 is a perspective view of the cover assembly of FIG. 4, shown fully assembled with a flanged access opening;

FIG. 7 is a perspective view of a cover assembly in accordance with an exemplary embodiment;

FIG. 8 is a perspective view of the cover assembly of FIG. 7, shown partially assembled with a flanged access opening;

FIG. 9 is a perspective view of the cover assembly of FIG. 7, shown fully assembled with a flanged access opening;

FIG. 10 is a partial front view of a cover assembly in accordance with an exemplary embodiment;

FIG. 11 is a front view of the flexible member locking mechanism of the cover assembly of FIG. 10;

FIG. 12 is a partial front view of a cover assembly in accordance with an exemplary embodiment;

FIG. 13 is an enlarged partial view of the flexible member of the cover assembly of FIG. 12;

FIG. 14 is a partial front view of another cover assembly in accordance with an exemplary embodiment;

FIG. 15 is an enlarged partial view of the flexible member of the cover assembly of FIG. 14;

FIG. 16 is a perspective view of a cover assembly in accordance with an exemplary embodiment;

FIG. 17 is a perspective view of the cover assembly of FIG. 16, shown partially assembled with a flanged access opening;

FIG. 18 is a perspective view of the cover assembly of FIG. 16, shown fully assembled with a flanged access opening;

FIG. 19 is a perspective view of a cover assembly in accordance with an exemplary embodiment;

FIG. 20 is a perspective view of the cover assembly of FIG. 19, shown partially assembled with a flanged access opening;

FIG. 21 is a perspective view of the cover assembly of FIG. 19, shown fully assembled with a flanged access opening;

FIG. 22 is a perspective view of a cover assembly in accordance with an exemplary embodiment;

FIG. 23 is a perspective view of the cover assembly of FIG. 22, shown partially assembled with a flanged access opening;

FIG. 24 is a perspective view of the cover assembly of FIG. 22, shown fully assembled with a flanged access opening;

FIG. 25 is a front view of a cover assembly in accordance with an exemplary embodiment;

FIG. 26 is a front view of a cover assembly in accordance with another exemplary embodiment;

FIG. 27 is a front view of a cover assembly in accordance with still another exemplary embodiment;

FIG. 28 is a front view of a cover assembly in accordance with another exemplary embodiment;

FIG. 29 is a perspective view of a cover assembly in accordance with an exemplary embodiment;

FIG. 30 is a front view of the cover assembly of FIG. 29, shown partially assembled with a flanged access opening;

FIG. 31 is a perspective view of the cover assembly of FIG. 29, shown fully assembled with a flanged access opening;

FIG. 32 is a perspective view of a cover assembly in accordance with an exemplary embodiment;

FIG. 33 is a front view of the cover assembly of FIG. 32, shown partially assembled with a flanged access opening;

FIG. 34 is a perspective view of the cover assembly of FIG. 32, shown fully assembled with a flanged access opening;

FIG. 35 is a front view of a cover assembly in accordance with an exemplary embodiment;

FIG. 36 is a front view of the cover assembly of FIG. 35, shown partially assembled with a flanged access opening;

FIG. 37 is a perspective view of the cover assembly of FIG. 35, shown fully assembled with a flanged access opening;

FIG. 38 is a front view of a cover assembly in accordance with an exemplary embodiment;

FIG. 39 is a front view of the cover assembly of FIG. 38, shown partially assembled with a flanged access opening;

FIG. 40 is a perspective view of the cover assembly of FIG. 38, shown fully assembled with a flanged access opening;

FIG. 41 is a front view of a cover assembly in accordance with an exemplary embodiment;

FIG. 42 is a front view of the cover assembly of FIG. 41, shown partially assembled with a flanged access opening;

FIG. 43 is a perspective view of the cover assembly of FIG. 41, shown fully assembled with a flanged access opening;

FIG. 44 is a front view of a cover assembly in accordance with an exemplary embodiment;

FIG. 45 is a front view of the cover assembly of FIG. 44, shown partially assembled with a flanged access opening;

FIG. 46 is a perspective view of the cover assembly of FIG. 44, shown fully assembled with a flanged access opening;

FIG. 47 is a front view of a cover assembly in accordance with an exemplary embodiment;

FIG. 48 is a perspective view of the cover assembly of FIG. 47, shown fully assembled with a flanged access opening;

FIG. 49 is a front view of a cover assembly in accordance with another exemplary embodiment;

FIG. 50 is a front view of a cover assembly in accordance with another exemplary embodiment, shown assembled with a flanged access opening;

FIG. 51 is a front view of a cover assembly in accordance with still another exemplary embodiment, shown assembled with a flanged access opening;

FIG. 52 is a perspective view of a cover assembly in accordance with yet another exemplary embodiment, shown assembled with a flanged access opening;

FIG. 53 is a front view of a cover assembly in accordance with an exemplary embodiment, shown assembled with a flanged access opening;

FIG. 54 is a front view of a cover assembly in accordance with another exemplary embodiment, shown assembled with a flanged access opening;

FIG. 54A is a perspective view of an exemplary quick connect fastener used with the cover assembly of FIG. 54;

FIG. 55 is a front view of a cover assembly in accordance with yet another exemplary embodiment, shown assembled with a flanged access opening;

FIG. 56 is a front view of a cover assembly in accordance with an exemplary embodiment;

FIG. 57 is a front view of the cover assembly of FIG. 56, shown partially assembled with a flanged access opening;

FIG. 58 is a perspective view of the cover assembly of FIG. 56, shown fully assembled with a flanged access opening;

FIG. 59 is a rear view of a cover assembly in accordance with an exemplary embodiment, shown in a cover releasing position;

FIG. 60 is a rear view of the cover assembly of FIG. 59, shown in a partially actuated position;

FIG. 61 is a rear view of the cover assembly of FIG. 59, shown in a cover securing position;

FIG. 62 is a perspective view of a cover assembly in accordance with an exemplary embodiment, shown in a cover releasing position;

FIG. 63 is a perspective view of the cover assembly of FIG. 62, shown in a partially actuated position;

FIG. 64 is a perspective view of the cover assembly of FIG. 62, shown in a cover securing position;

FIG. 65 is a perspective view of a cover assembly in accordance with an exemplary embodiment, shown in a cover releasing position;

FIG. 66 is a perspective view of the cover assembly of FIG. 65, shown in a partially actuated position;

FIG. 67 is a perspective view of the cover assembly of FIG. 65, shown in a cover securing position;

FIG. 68 is a perspective view of a cover assembly in accordance with an exemplary embodiment, shown in a cover releasing position;

FIG. 69 is a perspective view of the cover assembly of FIG. 68, shown in a partially actuated position;

FIG. 70 is a perspective view of the cover assembly of FIG. 68, shown in a cover securing position;

FIG. 71 is a perspective view of a cover assembly in accordance with an exemplary embodiment, shown in a cover releasing position;

FIG. 72 is a perspective view of the cover assembly of FIG. 71, shown in a partially actuated position;

FIG. 73 is a perspective view of the cover assembly of FIG. 71, shown in a cover securing position;

FIG. 74 is a perspective view of a cover assembly in accordance with an exemplary embodiment, shown in a cover releasing position;

FIG. 75 is a perspective view of the cover assembly of FIG. 74, shown in a partially actuated position;

FIG. 76 is a perspective view of the cover assembly of FIG. 74, shown in a cover securing position;

FIG. 77 is a perspective view of a frame member of a cover assembly in accordance with an exemplary embodiment, shown partially assembled with an access opening in a vessel;

FIG. 78 is a perspective view of the frame member of FIG. 77, shown fully installed in the access opening;

FIG. 79 is a perspective view of a cover assembly including the frame member of FIG. 77, shown fully assembled with the access opening;

FIG. 80 is a front view of a cover assembly in accordance with an exemplary embodiment, shown in a cover releasing position;

FIG. 81 is a front view of the cover assembly of FIG. 80, shown in a cover securing position;

FIG. 82 is a front view of a cover assembly in accordance with an exemplary embodiment, shown in a cover releasing position; and

FIG. 83 is a front view of the cover assembly of FIG. 82, shown in a cover securing position.

### DETAILED DESCRIPTION

This Detailed Description merely describes exemplary embodiments and is not intended to limit the scope of the claims in any way. Indeed, the invention as claimed is broader than and unlimited by the exemplary embodiments, and the terms used in the claims have their full ordinary meaning. For example, while many of the specific embodiments described herein show covering and/or locking devices used with a circular flanged manway to a confined space, the features of the present application may additionally or alternatively be applied to other types of covering and/or locking devices for use with other types (e.g., pipe connections, other access points, and non-flanged openings) and shapes (e.g., oval, square, rectangular, or irregular shaped) of openings, as well as use with other types of instruments and equipment.

A conventional access opening for a confined space includes a central orifice surrounded by an outer flange. An exemplary flange may include a ring of apertures for attachment of a cover (e.g., by bolts or other such fasteners). The weight and size of a conventional cover (e.g., a steel or other metal cover) may make such a cover inconvenient and unwieldy for use in temporarily blocking access to the access opening. Further, the dimensionally specific aperture arrangement on the flange prevents use of a single conventional cover with multiple sizes of flanges. According to an exemplary aspect of the present application, a flexible or adjustable cover assembly may be configured for use with a variety of sizes of flanges, and may be provided in a lightweight, easily manipulable construction, for example, to facilitate installation or removal by a single user.

In one embodiment, an access restricting cover for a flanged access opening includes a central covering portion sized to cover at least a portion of the access opening sufficient to block egress through the opening, and an outer flange-engaging portion configured to be secured to the flange. While many different configurations of covering and flange-engaging portions may be utilized, in an exemplary embodiment, the central covering portion includes a rigid, semi-rigid, or flexible sheet of material sized to cover all or part of the access opening, and the flange-engaging portion includes an outer peripheral collar provided in a flexible material that permits constriction of the collar over the flange to prevent or impede intentional or inadvertent removal of the cover from the manway, and selective expansion or loosening of the collar to permit authorized removal of the cover from the manway. The collar may be integral to or assembled with the covering portion.

While the exemplary covering portions described herein are shown as substantially solid, in other embodiments, the covering portion may be provided in a mesh, perforated, or apertured material, for example, to permit ventilation of the confined space. In other embodiments, one or more limited access openings may be provided, for example, an opening small enough to block egress but large enough for insertion of instruments (e.g., probes, ventilators) or for user inspection. In an exemplary embodiment, a limited access opening having a diameter less than eighteen inches, as permitted by OSHA, may be provided. In still other embodiments, a limited access opening may be selectively covered by a flap, door, or other movable obstruction, which may, but need not, be lockable in a closed position.

Many different arrangements may be utilized to control or limit constriction and expansion of the collar. In one embodiment, at least one flexible member (e.g., a rope, cable, cord, strap, belt, bungee, tether, or chain) is secured to the collar. The flexible member may be pulled, cinched, or otherwise tightened to constrict the collar around a flange of any suitable shape or size, or any other such enlarged end feature, and the flexible member may be released, slackened, or otherwise loosened to expand the collar away from the outer periphery of the flange for removal of the cover.

In an exemplary embodiment, the collar defines a passage along at least a portion of the collar, with the passage receiving at least one flexible member. At least a first end portion of the flexible member extends outward of the passage to permit tightening of the flexible member to constrict the collar around the flange, and loosening of the flexible member to expand the collar away from the outer periphery of the flange for removal of the cover. To retain the collar in a constricted condition (e.g., to prevent or impede removal of the cover from the access opening), the flexible member may be secured in the tightened condition by directly or indirectly securing the first end portion of the flexible member to at least one of the covering portion, the collar, and a second end portion of the flexible member. In one such embodiment, one or more apertures in the flexible member end may be aligned with one or more corresponding apertures affixed with the cover member when the flexible member is pulled to constrict the collar portion. Insertion of one or more locking members through the aligned apertures secures the collar portion in the constricted condition.

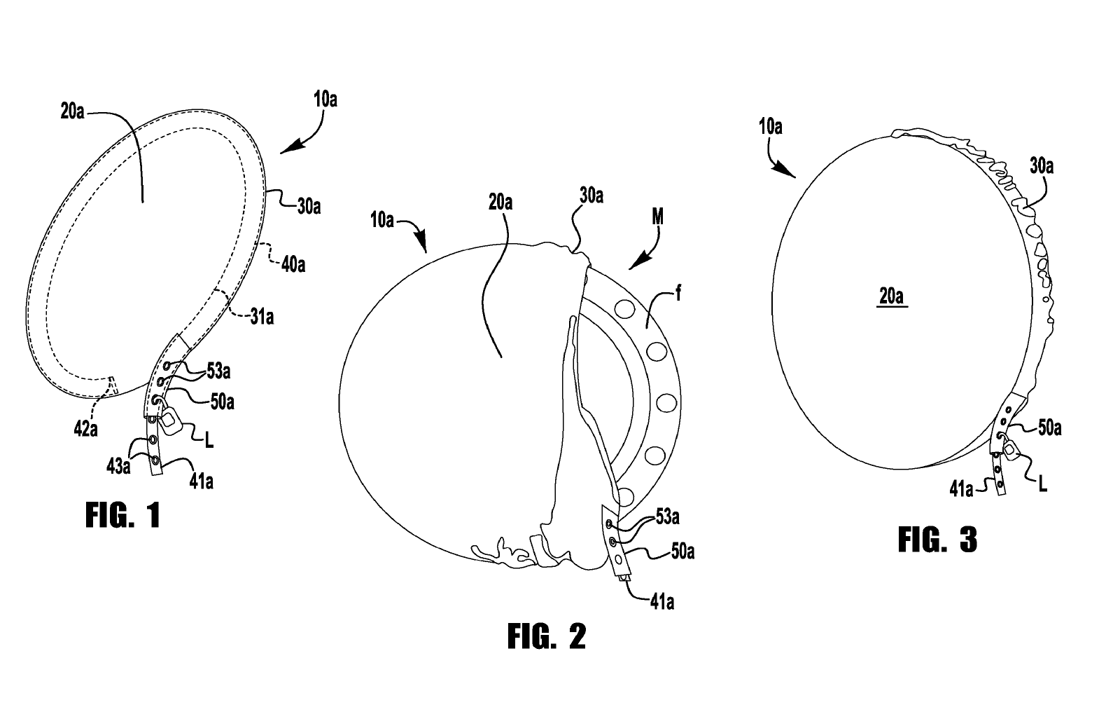

FIGS. 1-3 illustrate an exemplary cover assembly 10a including a central covering portion 20a surrounded by an outer peripheral collar portion 30a defining an internal passage 31a, and a strap-shaped flexible member 40a having a first end 41a extending outward of the passage 31a and a second end 42a secured to the collar portion 30a (e.g., secured within the internal passage 31a of the collar portion 30a). The first end 41a of the flexible member 40a extends through an apertured sleeved tab 50a secured to the collar portion 30a, and may be pulled, cinched or otherwise tightened to constrict the collar portion 30a around a flange f. To retain the collar portion 30a in this constricted condition (e.g., to prevent or impede removal of the cover 10a from the access opening M), the flexible member 40a may be secured in the tightened condition by securing a locking member L (e.g. a padlock, zip-tie, or other such locking device) through aligned apertures 43a, 53a in the first end of the flexible member 40a and the sleeved tab 50a. As shown, either or both of the first end of the flexible member 40a and the sleeved tab 50a may be provided with multiple apertures 43a, 53a to allow the amount of secured cinching to be varied (for example, to accommodate different sized flanges), and/or to allow multiple locking members L to secure the flexible member in a tightened condition. To remove the cover 10a from the access opening M, the locking member L is removed from the aligned apertures 43a, 53a and the collar portion 30a is expanded (e.g. by user-applied pulling forces or automatic loosening of the unsecured flexible member) to slip the cover 10a off of the flange f.

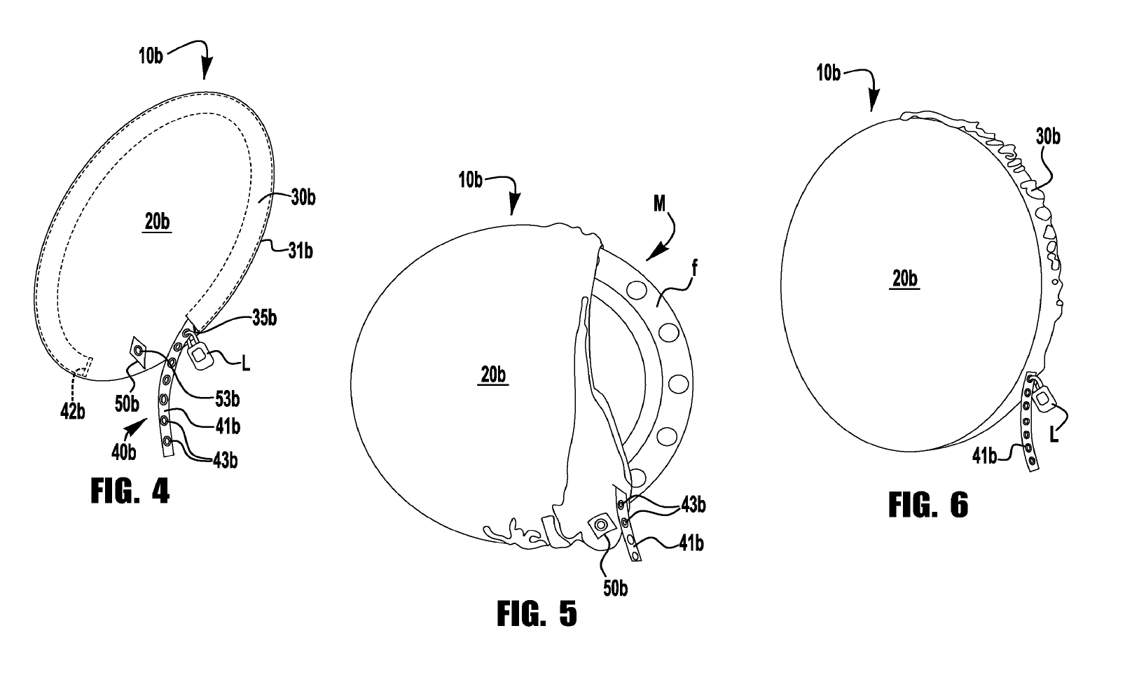

FIGS. 4-6 illustrate another exemplary cover assembly 10b including a central covering portion 20b surrounded by an outer peripheral collar portion 30b defining an internal passage 31b, and a strap-shaped flexible member 40b having a first end 41b extending outward of the passage 31b and a second end 42b secured to the collar portion 30b (e.g., secured within the internal passage 31b of the collar portion 30b). The first end 41b of the flexible member 40b extends through an opening 35b in the collar portion 30b, and may be pulled, cinched or otherwise tightened to constrict the collar portion 30b around the flange f. To retain the collar portion 30b in this constricted condition (e.g., to prevent or impede removal of the cover 10b from the access opening M), the flexible member 40b may be secured in the tightened condition by securing a locking member L (e.g. a padlock, zip-tie, or other such locking device) through aligned apertures 43b, 53b in the first end of the flexible member 40b and a tab 50b secured to an outer surface of the cover 10b. Either or both of the first end of the flexible member 40b and the tab 50b may be provided with multiple apertures 43b, 53b to allow the amount of secured cinching to be varied (for example, to accommodate different sized flanges). To remove the cover 10b from the access opening M, the locking member L is removed from the aligned apertures 43b, 53b and the collar portion 30b is expanded (e.g. by user-applied pulling forces or automatic loosening of the unsecured flexible member) to slip the cover 10b off of the flange f.

In other embodiments, a cover for a flanged access opening (of any of a variety of shapes and sizes) or any other such enlarged end feature may include a flexible member retaining collar having both ends of the flexible member extending outward of the collar. To retain the collar in a constricted condition (e.g., to prevent or impede removal of the cover from the access opening), the flexible member is tightened or cinched and the first and second ends of the flexible member are directly or indirectly secured to each other in a tightened condition.

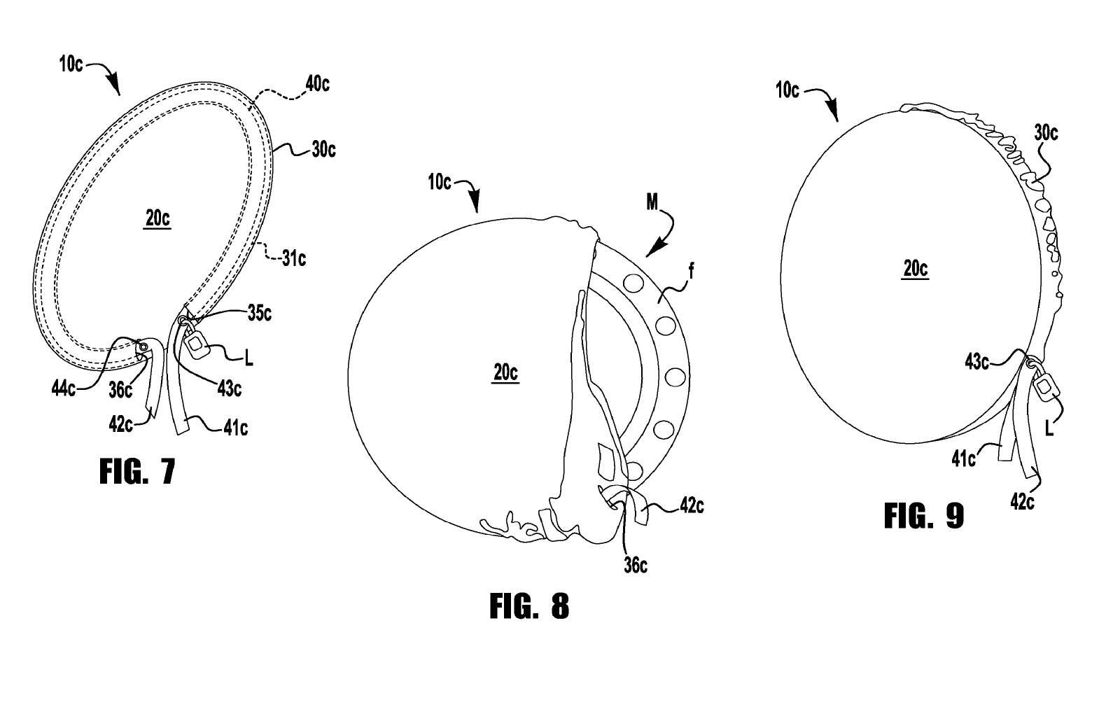

FIGS. 7-9 illustrate another exemplary cover assembly 10c including a central covering portion 20c surrounded by an outer peripheral collar portion 30c defining an internal passage 31c. A strap-shaped flexible member 40c is assembled with the collar portion 30c and includes a first end 41c extending outward of the passage 31c through a first opening 35c in the collar portion 30c and a second end 42c extending outward of the passage 31c through a second opening 36c in the collar portion 30e. The first and second ends 41c, 42c may be pulled, cinched or otherwise tightened to constrict the collar portion 30c around the flange f. The first and second ends 41c, 42c of the flexible member 40c each include one or more apertures 43c, 44c. To retain the collar portion 30c in the constricted condition (e.g., to prevent or impede removal of the cover 10c from the access opening), the flexible member 40c may be secured in the tightened condition by inserting a locking member L (e.g. a padlock, zip-tie, or other such locking device) through aligned apertures 43c, 44c in the first and second flexible member ends 41c, 42c. To remove the cover 10c from the access opening M, the locking member L is removed from the aligned apertures 43c, 44c and the collar portion 30c is expanded (e.g. by user-applied pulling forces or automatic loosening of the unsecured flexible member) to slip the cover 10c off of the flange f.

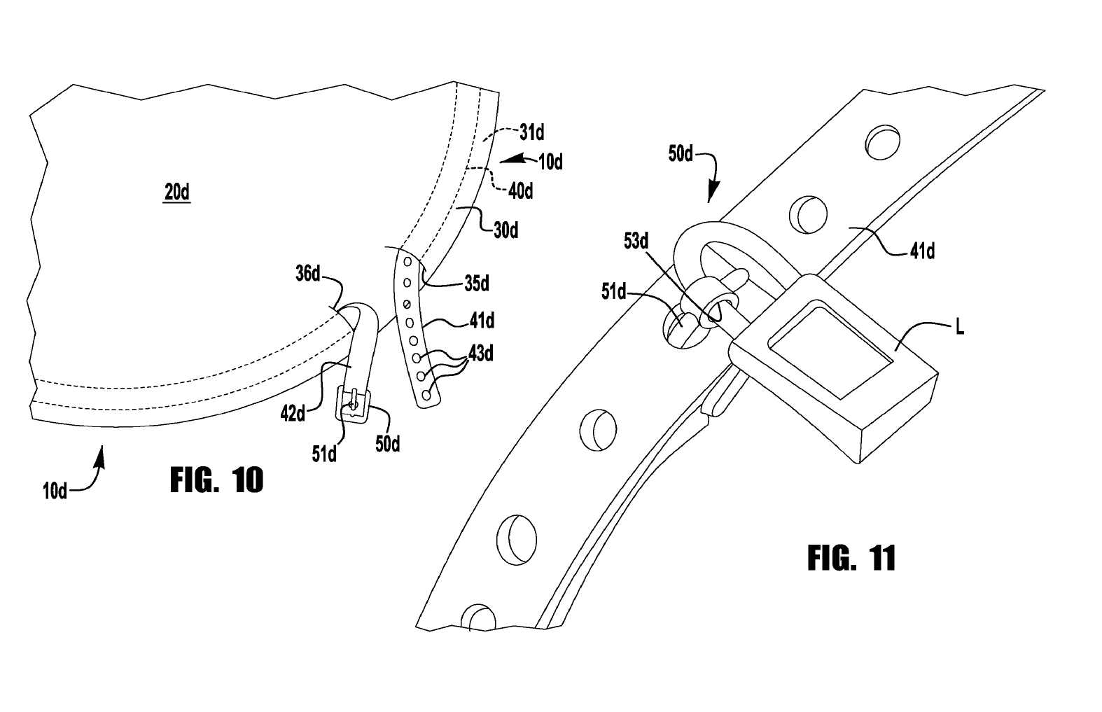

FIGS. 10 and 11 illustrate another exemplary cover assembly 10d including a central covering portion 20d surrounded by an outer peripheral collar portion 30d defining an internal passage 31d. A strap-shaped flexible member 40d is assembled with the collar portion 30d and includes a first end 41d extending outward of the passage 31d through a first opening 35d in the collar portion 30d and a second end 42d extending outward of the passage 31d through a second opening 36d in the collar portion 30d. The first and second ends 41d, 42d may be pulled, cinched or otherwise tightened to constrict the collar portion 30d around the flange. The first end 41d of the flexible member 40d includes a set of apertures 43d, and the second end 42d of the flexible member includes a buckle 50d. To retain the collar portion 30d in the constricted condition (e.g., to prevent or impede removal of the cover 10d from the access opening), the flexible member 40d may be secured in the tightened condition by inserting a tine 51d of the buckle 50d through a selected aperture 43d in the first end 41d of the flexible member 40d. As shown, the tine 51d may include a lock aperture 53d sized to receive a locking member L (e.g. a padlock, zip-tie, or other such locking device) to prevent withdrawal of the tine 51d from the flexible member aperture 43d. To remove the cover 10d from the access opening, the locking member L is removed from the tine lock aperture 53d, the first end 41d of the flexible member is disengaged from the tine 51d, and the collar portion 30d is expanded (e.g. by user-applied pulling forces or automatic loosening of the unsecured flexible member) to slip the cover 10d off of the flange. In some embodiments, a flexible member may include a low friction outer surface or coating to promote automatic loosening of the flexible member upon release of a securing engagement (e.g., release of a cinching lock, ratchet tie-down or buckle-type clasp, examples of which are described below).

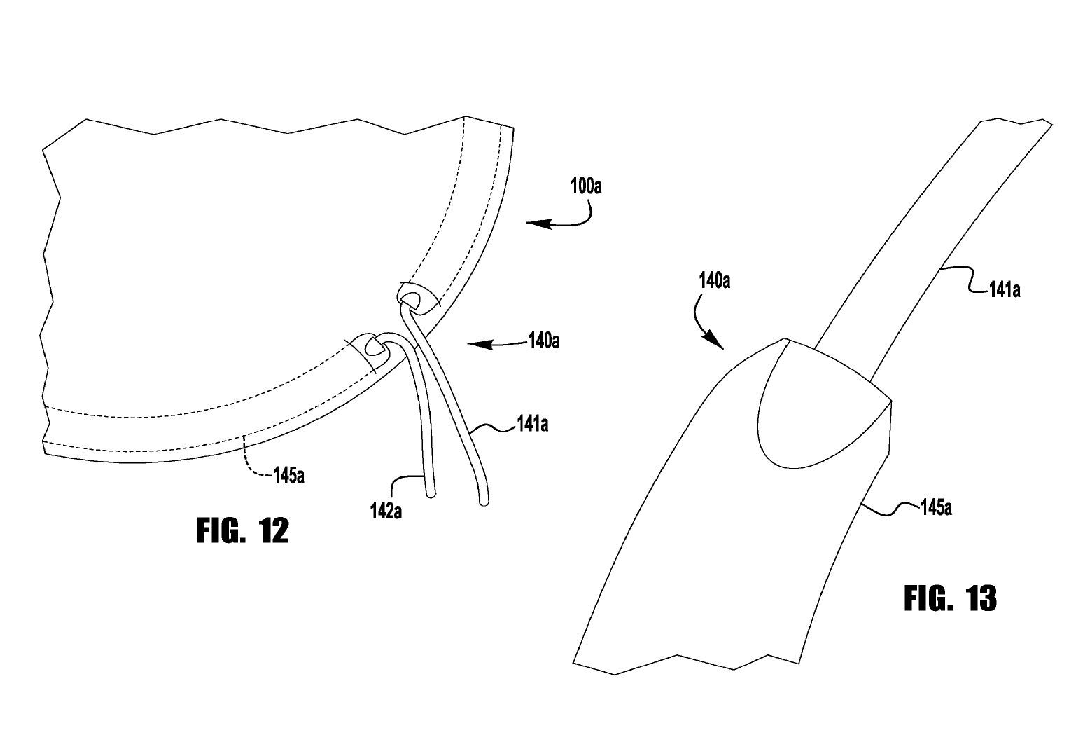

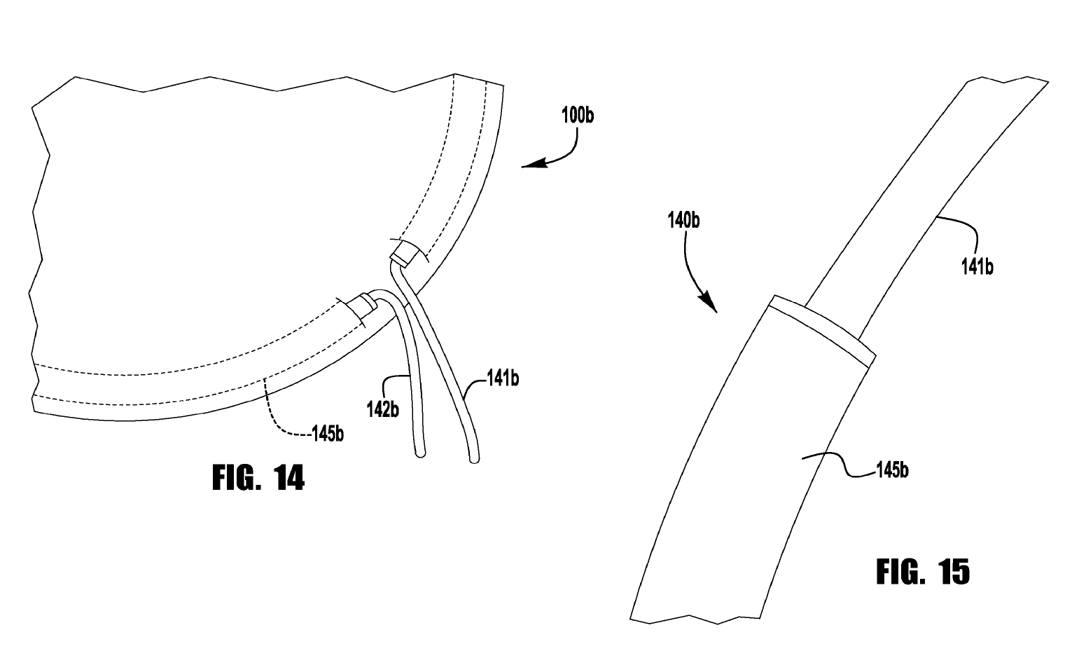

Many different types of flexible members may be used to tighten a collar portion of a cover assembly around an access flange, including, for example, straps, chains, cables, tethers, and bungees. In one embodiment, a flexible member may include an intermediate section of a first shape, material, or other such property (for example, to provide more uniform constricting forces on the collar), and end portions of a second material, shape, or other such property (for example, to facilitate tying, fastening, locking, or other user manipulation of the flexible member ends). FIGS. 12-15 illustrate two exemplary embodiments of a flexible member 140a, 140b having a widened, strap-shaped intermediate section 145a, 145b secured to first and second cable-shaped end portions 141a, 142a, 141b, 142b. The cable ends may be secured using a cable locking device (for example, as described below) or any other suitable mechanism.

In some embodiments, a flexible member gripping mechanism may be used to secure the flexible member in a collar constricting condition. In one such embodiment, the flexible member gripping mechanism is affixed to a first end of the flexible member, and is operable to grip a portion of a second end of the flexible member to secure the collar portion of the cover member in a selected constricted condition. As described in greater detail below, the flexible member gripping mechanism may be configured to be locked in this gripping condition, for example, by insertion of a lock member (e.g., a padlock shackle) through one or more lock apertures in the flexible member gripping mechanism.

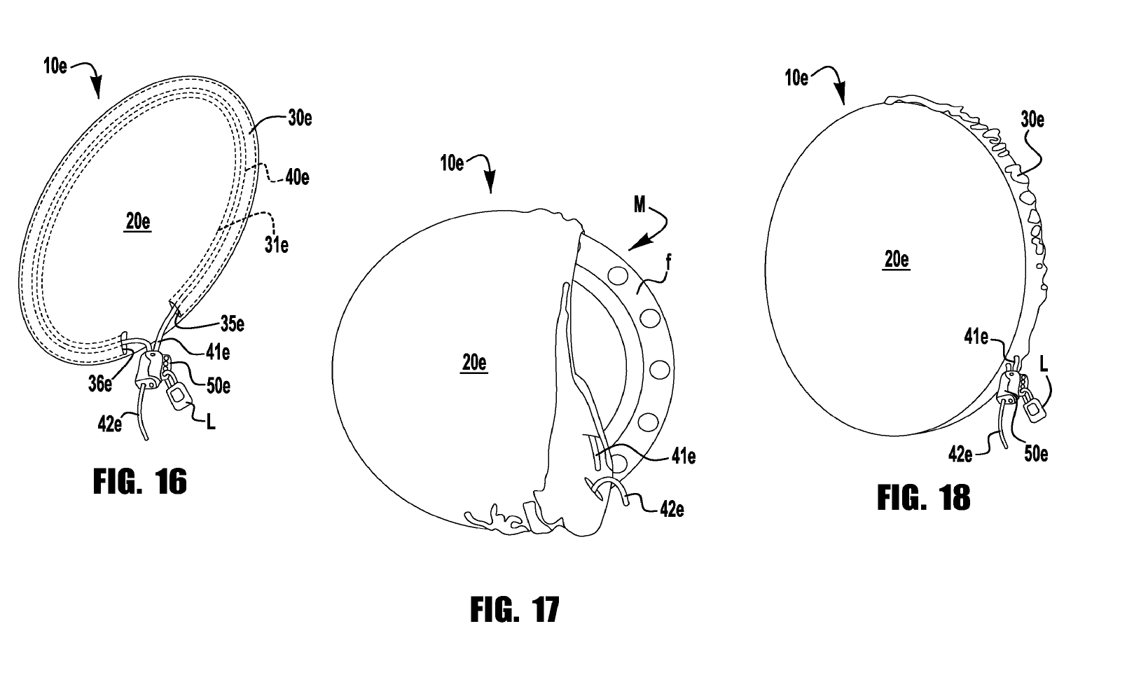

FIGS. 16-18 illustrate another exemplary cover assembly 10e including a central covering portion 20e surrounded by an outer peripheral collar portion 30e defining an internal passage 31e. A cable 40e (or other such flexible member) is assembled with the collar portion 30e and includes a first end 41e extending outward of the passage 31e through a first opening 35e in the collar portion 30e and a second end 42e extending outward of the passage 31e through a second opening 36e in the collar portion 30e. The first and second ends 41e, 42e may be pulled, cinched or otherwise tightened to constrict the collar portion 30e around the flange f. To retain the collar portion 30e in the constricted condition (e.g., to prevent or impede removal of the cover 10e from the access opening M), the flexible member 40e may be secured in the tightened condition by securing a cable locking arrangement 50e to the first and second flexible member ends 41e, 42e. While any suitable cable locking arrangement may be used, in an exemplary embodiment, an adjustable cable lockout model no. 5806, manufactured by Master Lock, may be utilized. The exemplary cable locking arrangement 50e may be secured in a cable clamping condition by securing one or more lock members L (e.g. a padlock, zip-tie, or other such locking device) through aligned lock apertures in the cable lockout device 50e. To remove the cover 10e from the access opening M, the locking member L is removed from the aligned apertures of the cable lockout device 50e, the cable lockout device is loosened or disassembled from the ends of the flexible member 40e, and the collar portion 30e is expanded (e.g. by user-applied pulling forces or automatic loosening of the unsecured flexible member) to slip the cover 10e off of the flange f.

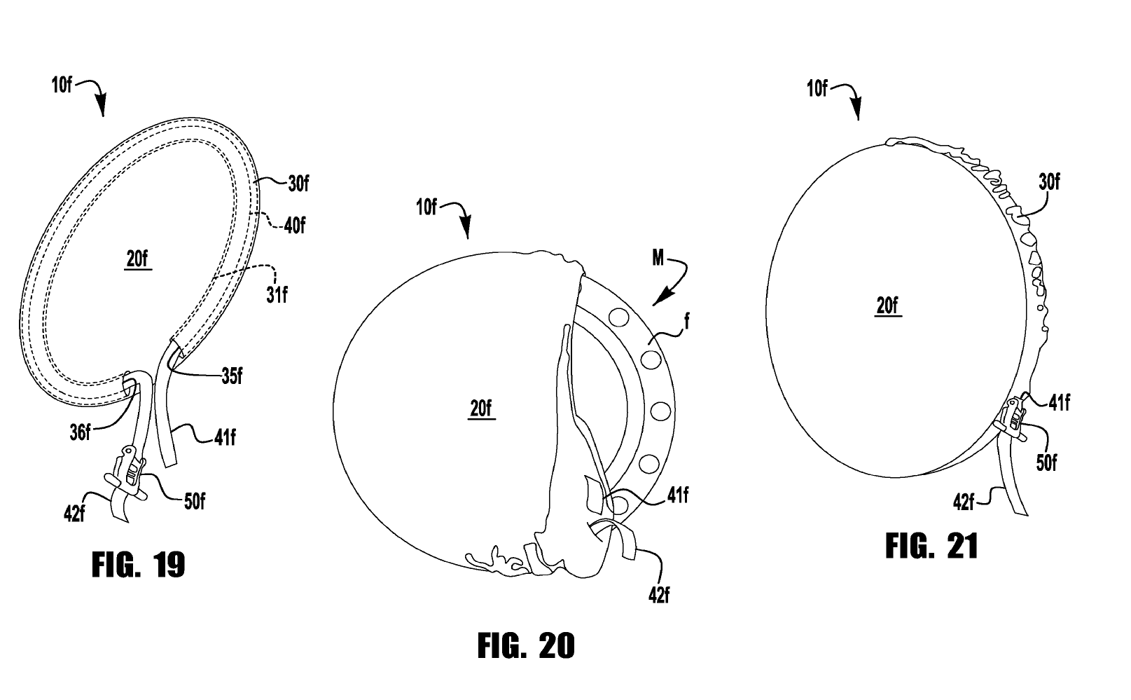

FIGS. 19-21 illustrate another exemplary cover assembly 10f including a central covering portion 20f surrounded by an outer peripheral collar portion 30f defining an internal passage 31f. A strap-shaped flexible member 40f is assembled with the collar portion 30f and includes a first end 41f extending outward of the passage 31f through a first opening 35f in the collar portion 30f and a second end 42f extending outward of the passage 31f through a second opening 36f in the collar portion 30f. The first and second ends 41f, 42f may be pulled, cinched or otherwise tightened to constrict the collar portion 30f around the flange f. To retain the collar portion 30f in the constricted condition (e.g., to prevent or impede removal of the cover 10f from the access opening M), the flexible member 40f may be secured in the tightened condition by securing a strap ratcheting device 50f to the first and second flexible member ends 41f, 42f. While any suitable strap ratcheting device may be used, in an exemplary embodiment, an endless ratchet tie down model no. 3504DAT, manufactured by Master Lock Co., may be utilized. To remove the cover 10f from the access opening M, the ratcheting device 50f is released to loosen the flexible member 40f, and the collar portion 30f is expanded (e.g. by user-applied pulling forces or automatic loosening of the unsecured flexible member) to slip the cover 10f off of the flange f.

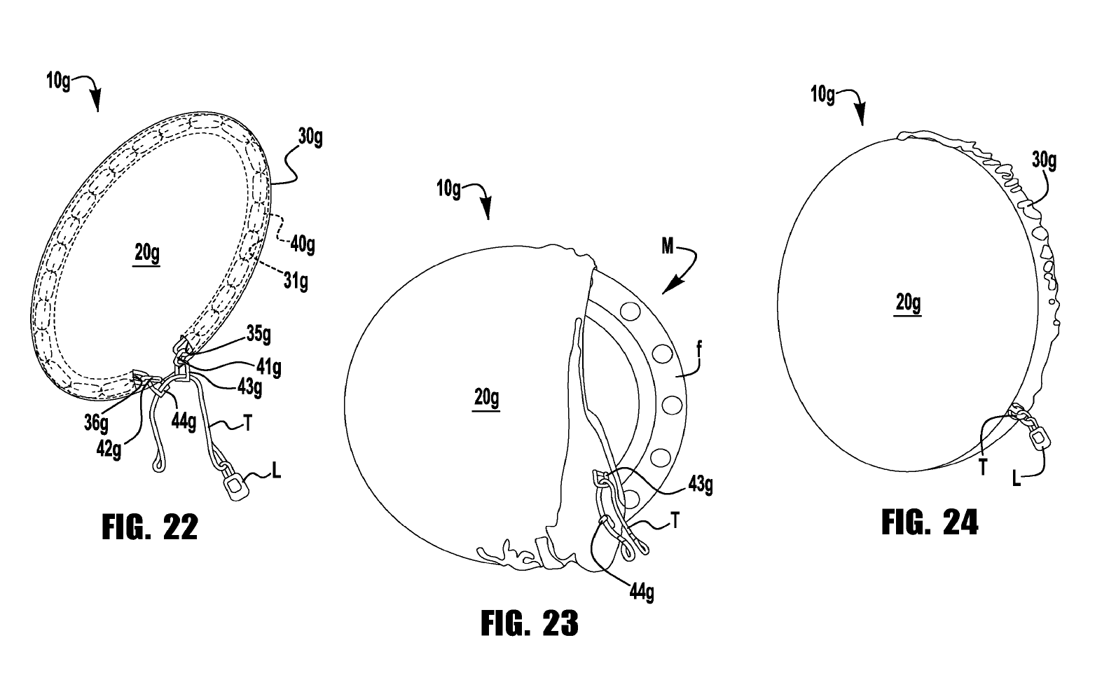

FIGS. 22-24 illustrate another exemplary cover assembly 10g including a central covering portion 20g surrounded by an outer peripheral collar portion 30g defining an internal passage 31g. A chain 40g (or other such flexible member) is assembled with the collar portion 30g and includes a first end 41g extending outward of the passage 31g through a first opening 35g in the collar portion 30g and a second end 42g extending outward of the passage 31g through a second opening 36g in the collar portion 30g. The first and second ends 41g, 42g may be pulled, cinched or otherwise tightened to constrict the collar portion 30g around the flange f. To retain the collar portion 30g in the constricted condition (e.g., to prevent or impede removal of the cover 10g from the access opening), the flexible member 40g may be secured in the tightened condition by inserting a locking member L (e.g. a padlock, zip-tie, or other such locking device) through chain links 43g, 44g in the first and second flexible member ends 41g, 42g. While a padlock or other locking member may be installed directly through one of the chain links 43g, 44g in each end 41g, 42g, in the illustrated embodiment, the end links are secured together by a tie-down bungee or tether T wrapped through the end links, with a padlock secured through end loops in the tether T to prevent loosening. The tether T may be wrapped through intermediate (i.e. not the endmost) chain links 43g, 44g or wrapped through the chain links multiple times to provide sufficient constriction of the flexible member 40g. To remove the cover 10g from the access opening M, the locking member L is removed from the tether T, the tether is removed from the end links 43g, 44g, and the collar portion 30g is expanded (e.g. by user-applied pulling forces or automatic loosening of the unsecured flexible member) to slip the cover 10g off of the flange f. In other embodiments, other types of flexible members having looped or apertured ends (e.g., straps, cables, etc.) may be secured in a tightened condition in a similar fashion.

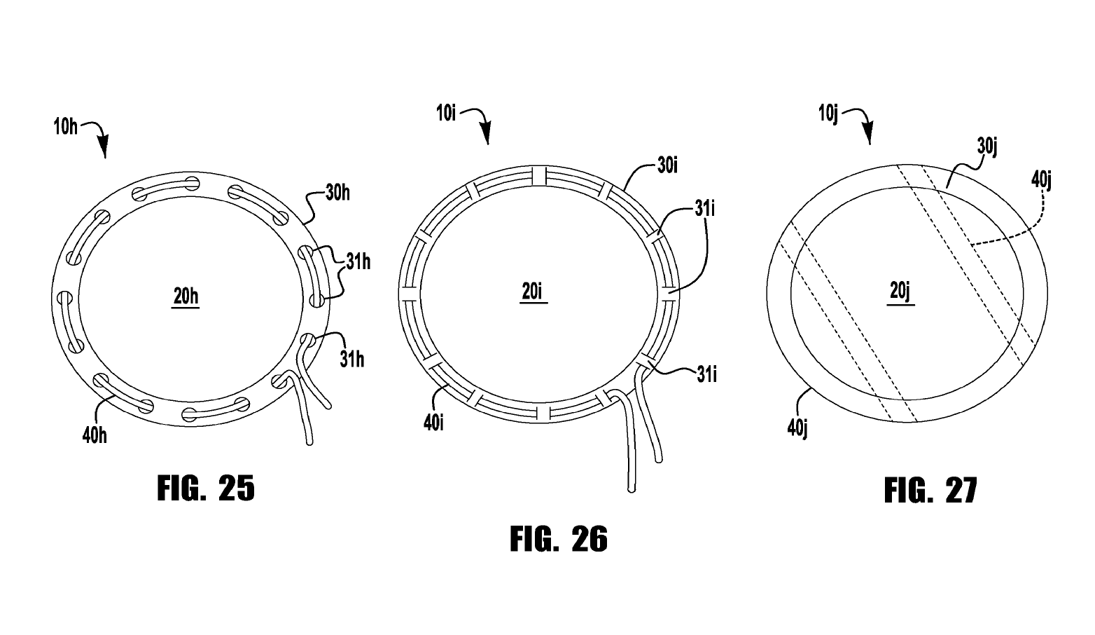

In other embodiments, other arrangements may be used to secure a collar portion of a cover to a flange (e.g., a manway flange) or other such enlarged end feature. In one exemplary embodiment, as shown in FIG. 25, a cover 10h includes a central covering portion 20h surrounded by an outer peripheral collar portion 30h including a series of holes 31h through which a flexible member 40h is laced, permitting tightening of the flexible member 40h to constrict the collar portion 30h over a flange. The flexible member 40h may be secured in the tightened condition using any suitable arrangement, including, for example, one or more of the exemplary locking or fastening arrangements described herein. In another exemplary embodiment, as shown in FIG. 26, a cover 10i includes a central covering portion 20i surrounded by an outer peripheral collar portion 30i including a series of loops 31i under which a flexible member 40i is inserted, permitting tightening of the flexible member 40i to constrict the collar portion 30i over a flange. The flexible member 40i may be secured in the tightened condition using any suitable arrangement, including, for example, one or more of the exemplary locking or fastening arrangements described herein.

In still another exemplary embodiment, as shown in FIG. 27, a cover 10j includes a central covering portion 20j surrounded by an outer peripheral collar portion 30j that is folded or wrapped over the outer periphery of a flange and secured in this wrapped condition by one or more fastening straps 40j extending from one portion of the collar behind the flange and secured to an opposed second portion of the collar, for example, using one or more of the exemplary adjustable locking, cinching, gripping, or fastening arrangements described herein. Alternatively, the strap may be permanently secured to the first and second opposed portions of the collar portion, and adjustable in length, for example, using buckles, ties, or other cinching or bundling mechanisms. The strap 40j may be wrapped around a base portion of the access point (e.g., pipe or vessel), beneath the flange, for a more secure attachment. In another exemplary embodiment, as shown in FIG. 28, a cover 10k includes a central covering portion 20k surrounded by an outer peripheral collar portion 30k that includes an elastic material configured to stretch over the outer periphery of a flange and constrict onto the flange. The collar portion 30k may (but need not) be secured in this wrapped condition by one or more fastening straps 40k extending from one portion of the collar behind the flange and secured to a second portion of the collar, for example, using one or more of the exemplary adjustable locking, cinching, gripping, or fastening arrangements described herein. Alternatively, the strap may be permanently secured to the first and second opposed portions of the collar portion, and adjustable in length, for example, using buckles, ties, or other cinching or bundling mechanisms. The straps 40k may be wrapped around a base portion of the access point (e.g., pipe or vessel), beneath the flange, for a more secure attachment.

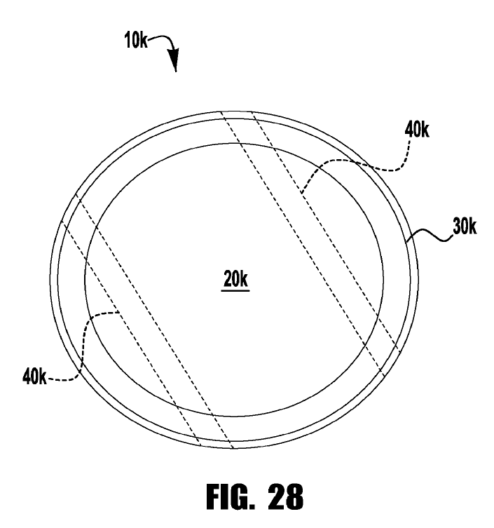

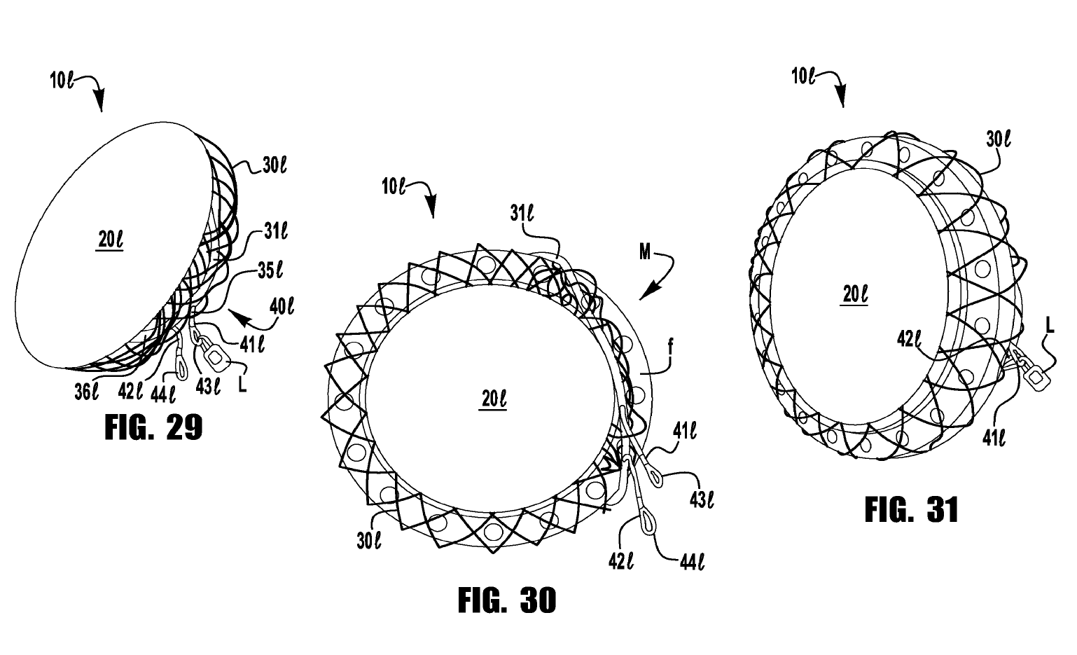

In still other embodiments, other types of collar arrangements may be utilized. For example, a webbing material may be secured around an outer periphery of a central covering portion. A collar securing flexible member may be integral with, woven or laced through, or otherwise installed with the webbing. FIGS. 29-31 illustrate another exemplary cover assembly 10l including a central covering portion 20l surrounded by an outer peripheral webbing collar portion 30l including an outer peripheral sheath 31l. A cable 40l (or other such flexible member) is installed through the sheath 31l and includes a first end 41l extending outward of the sheath 31l through a first opening 35l in the sheath 31l and a second end 42l extending outward of the sheath 31l through a second opening 36l in the sheath 31l. The first and second ends 41l, 42l may be pulled, cinched or otherwise tightened to constrict the collar portion 30l around the flange f. To retain the collar portion 30l in the constricted condition (e.g., to prevent or impede removal of the cover 10l from the access opening), the flexible member 40l may be secured in the tightened condition by inserting a locking member L (e.g. a padlock, zip-tie, or other such locking device) through end loops 43l, 44l in the first and second flexible member ends 41l, 42l, or by securing the end loops together using a tie-down bungee (as shown, for example, in FIGS. 22-24). To remove the cover 10l from the access opening M, the locking member L is removed from the end loops 43l, 44l, and the collar portion 30l is expanded (e.g. by user-applied pulling forces or automatic loosening of the unsecured flexible member) to slip the cover 10l off of the flange f. In other embodiments, other types of flexible members having looped or apertured ends (e.g., straps, chains, etc.) may be secured in a tightened condition in a similar fashion.

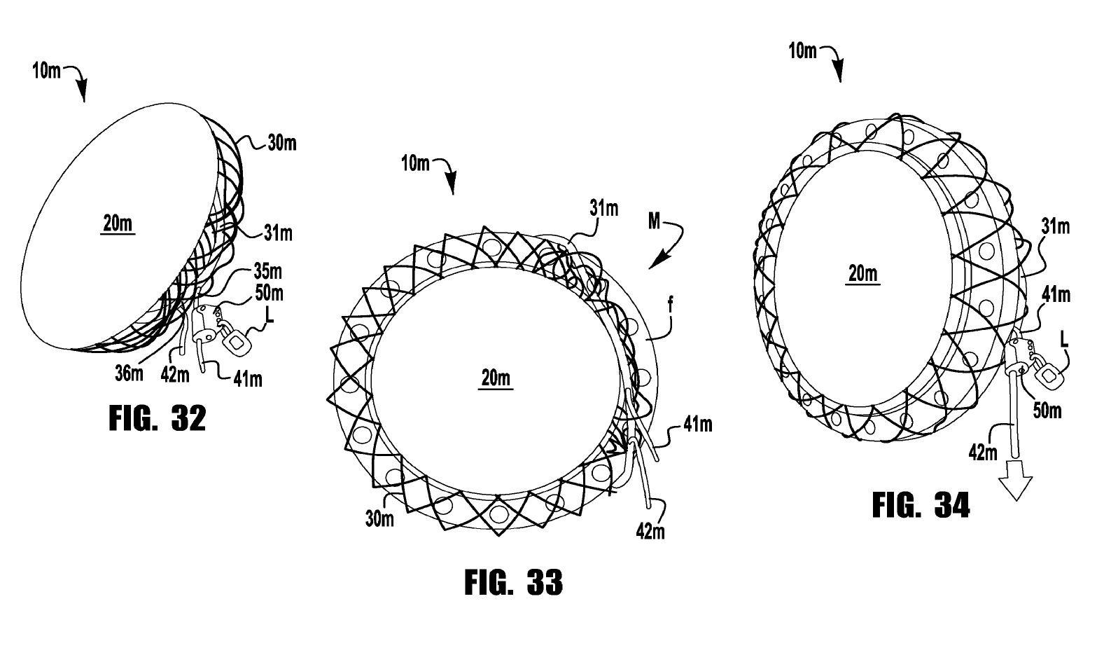

In other embodiments, a collar portion of a cover assembly may include a webbing of strands (e.g., cables, straps, chains, etc). The webbing may be loose or elastic to permit wrapping or extension of the webbing around a flange or other enlarged end portion of an access opening or device. A cover securing flexible member may be threaded between the strands of the webbing, or received through a sleeve or sheath secured to the webbing. FIGS. 32-34 illustrate an exemplary cover assembly 10m including a central covering portion 20m surrounded by an outer peripheral webbing collar portion 30m including an outer peripheral sheath 31m. A cable 40m (or other such flexible member) is installed through the sheath 31m and includes a first end 41m extending outward of the sheath 31m through a first opening 35m in the sheath 31m and a second end 42m extending outward of the sheath 31m through a second opening 36m in the sheath 31m. The first and second ends 41m, 42m may be pulled, cinched or otherwise tightened to constrict the collar portion 30m around the flange f. To retain the collar portion 30m in the constricted condition (e.g., to prevent or impede removal of the cover 10m from the access opening M), the flexible member 40m may be secured in the tightened condition by securing a cable locking arrangement 50m to the first and second flexible member ends 41m, 42m. While any suitable cable locking arrangement may be used, in an exemplary embodiment, an adjustable cable lockout model no. S806, manufactured by Master Lock, may be utilized. The exemplary cable locking arrangement 50m may be secured in a cable clamping condition by securing one or more lock members L (e.g. a padlock, zip-tie, or other such locking device) through aligned lock apertures in the cable lockout device 50m. To remove the cover 10m from the access opening M, the locking member L is removed from the aligned apertures of the cable lockout device 50m, the cable lockout device is loosened or disassembled from the ends of the flexible member 40m, and the collar portion 30m is expanded (e.g. by user-applied pulling forces or automatic loosening of the unsecured flexible member) to slip the cover 10m off of the flange f.

In other embodiments, a safety cover for a flanged access opening (or other enlarged end feature) may include other types of flange engaging members for securing a central covering portion over the access opening. For example, the cover may include one or more hook ended members, with each hook being sized to hook over an outer edge of the flange. The hooks may include a soft outer coating (e.g., rubber, plastic) to prevent marring of the flange. While the hook ended members may be affixed directly to the central covering portion, in another embodiment, a pair of crossing hook ended straps are threaded through openings in the central covering portion and hooked onto opposed edges of the flange. In other embodiments, a different number of hook ended straps (e.g., one or more than two) may be used. In still other embodiments, one or more straps may be provided with a first end affixed (e.g., sewn, fastened) directly to the covering portion and a second hooked end configured to fit over an outer edge of the flange.

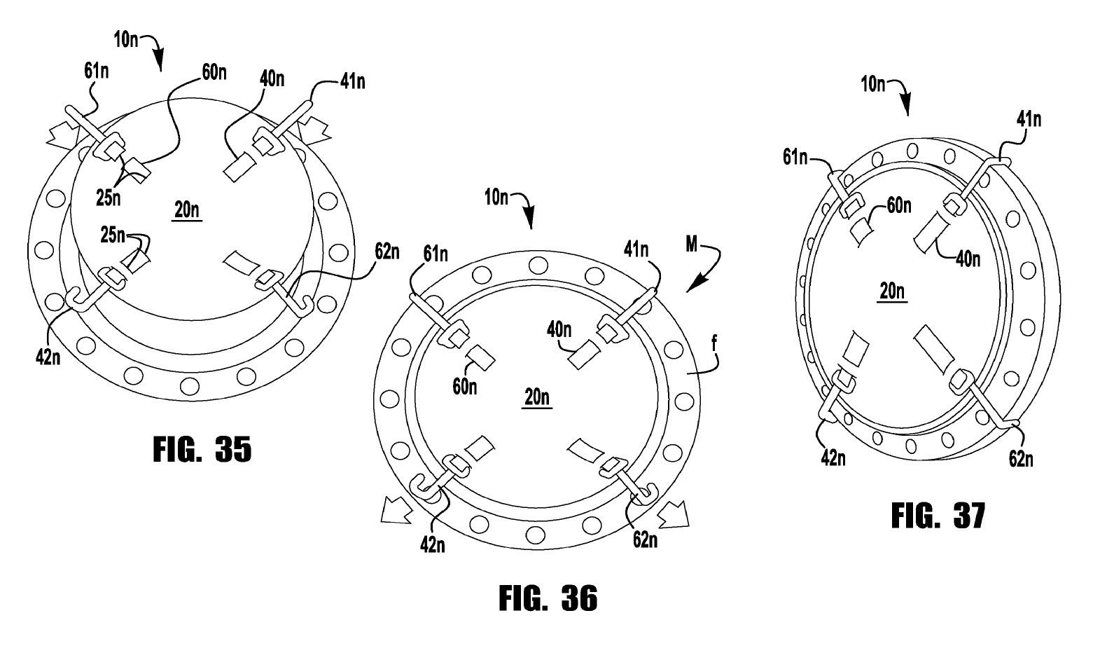

FIGS. 35-37 illustrate an exemplary safety cover 10n including a central covering portion 20n and first and second straps 40n, 60n threaded through openings 25n in the central covering portion. As shown, the straps 40n, 60n may be oriented in an X-shaped configuration. Each of the straps includes first and second hooks 41n, 42n, 61n, 62n sized to fit over an outer edge of the flange f. The straps 40n, 60n may be provided in an elastic material to permit stretching of straps to fit flanges of varying size and to provide secure gripping engagement of the hooks on the flange f.

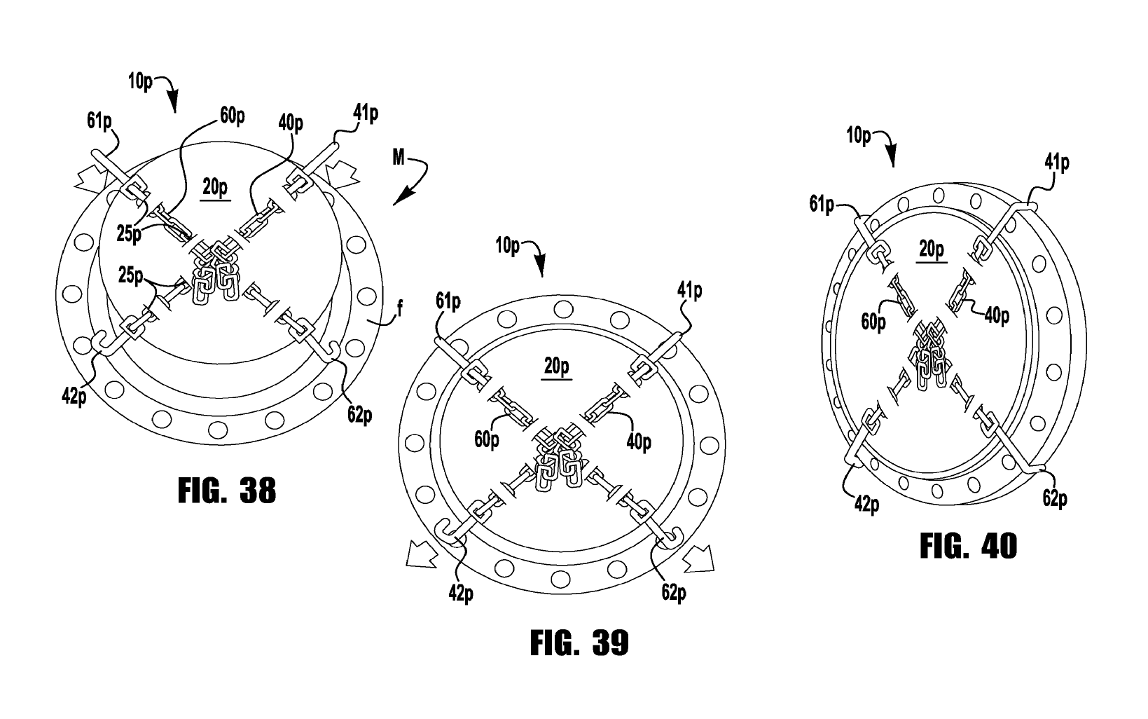

FIGS. 38-40 illustrate an exemplary safety cover 10p including a central covering portion 20p and first and second chain straps 40p, 60p threaded through openings 25p in the central covering portion. As shown, the straps 40p, 60p may be oriented in an X-shaped configuration. Each of the straps includes first and second hooks 41p, 42p, 61p, 62p sized to fit over an outer edge of the flange f. As shown, intermediate portions of the chains 40p, 60p may be wrapped or bundled to shorten the effective length of the straps to provide secure gripping engagement of the hooks on the flange f.

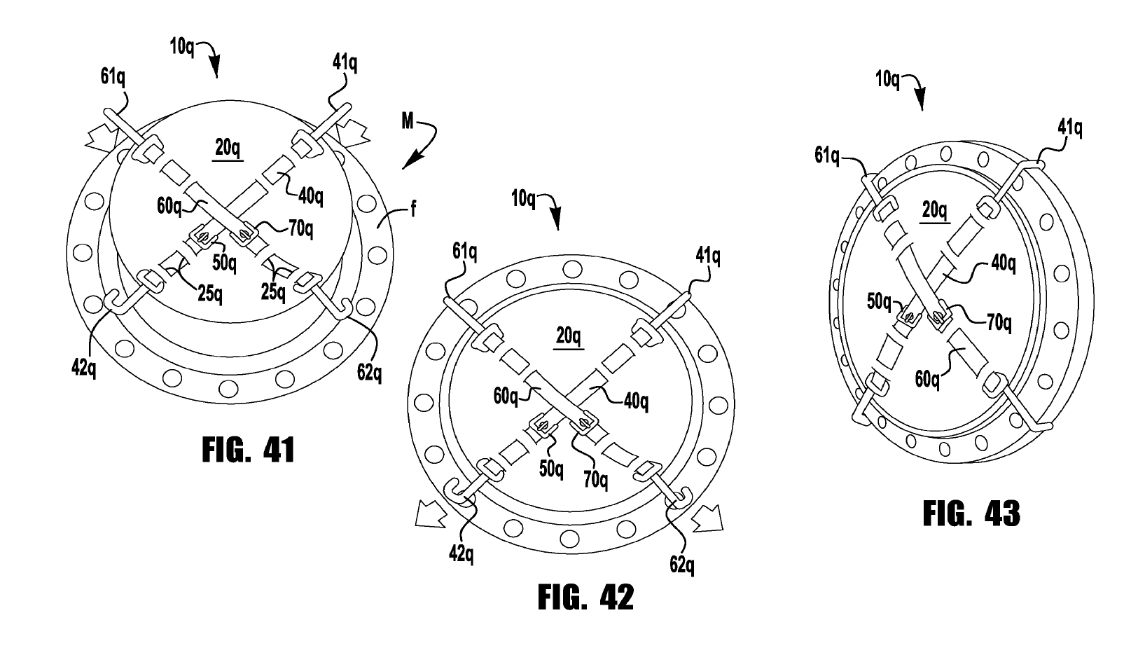

In some embodiments, a safety cover may include one or more adjusting devices (e.g., dials, spools, reels, ratchets, etc.) to lengthen hook ended members (e.g., straps, plates, etc.) to fit the cover over a flange or other enlarged end feature, and to shorten the hook ended members to provide secure gripping engagement of the hooks on the flange. FIGS. 41-43 illustrate an exemplary safety cover 10q including a central covering portion 20q and first and second adjustable straps 40q, 60q threaded through openings 25q in the central covering portion. As shown, the straps 40q, 60q may be oriented in an X-shaped configuration. Each of the straps includes first and second hooks 41q, 42q, 61q, 62q sized to fit over an outer edge of the flange f. As shown, the effective lengths of the straps 40q, 60q may be adjusted by buckle arrangements 50q, 70q to shorten the straps to provide secure gripping engagement of the hooks on the flange f. The buckle arrangements may, but need not, include padlock securing tines as shown and described above in the embodiment of FIGS. 10 and 11.

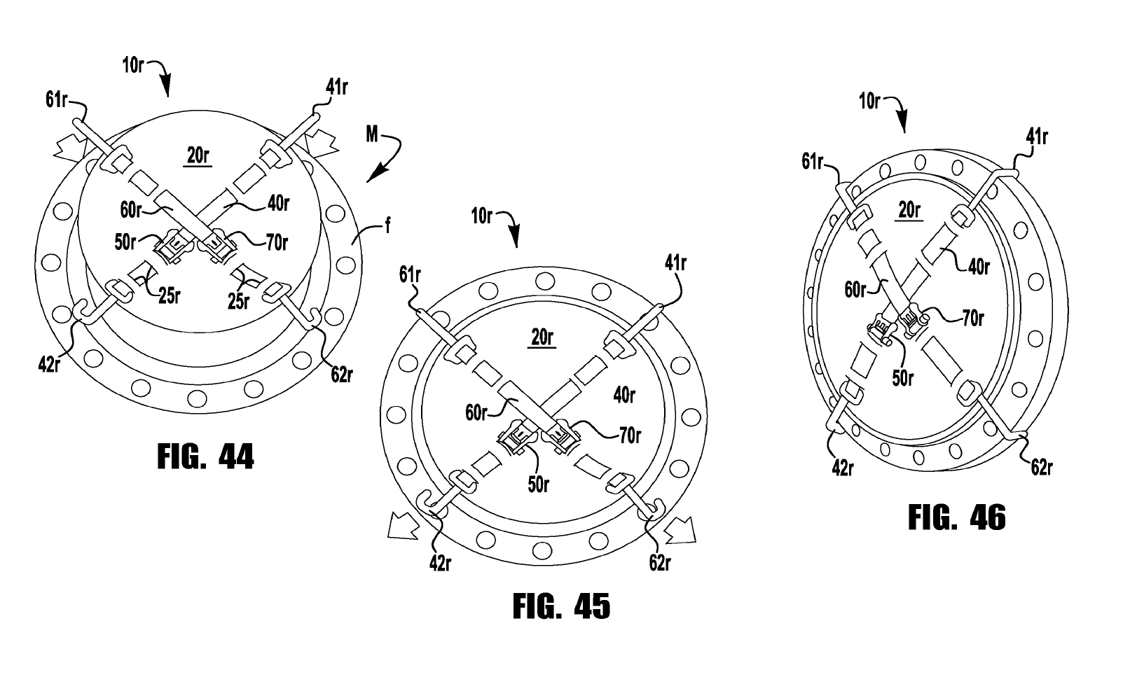

FIGS. 44-46 illustrate an exemplary safety cover 10r including a central covering portion 20r and first and second adjustable straps 40r, 60r threaded through openings 25r in the central covering portion. As shown, the straps 40r, 60r may be oriented in an X-shaped configuration. Each of the straps includes first and second hooks 41r, 42r, 61r, 62r sized to fit over an outer edge of the flange f. As shown, intermediate portions of the straps 40r, 60r may be adjusted by ratchet strap arrangements 50r, 70r to shorten the straps to provide secure gripping engagement of the hooks on the flange f. The ratchet strap arrangements may, but need not, be consistent with the ratchet strap device shown and described above in the embodiment of FIGS. 19-21.

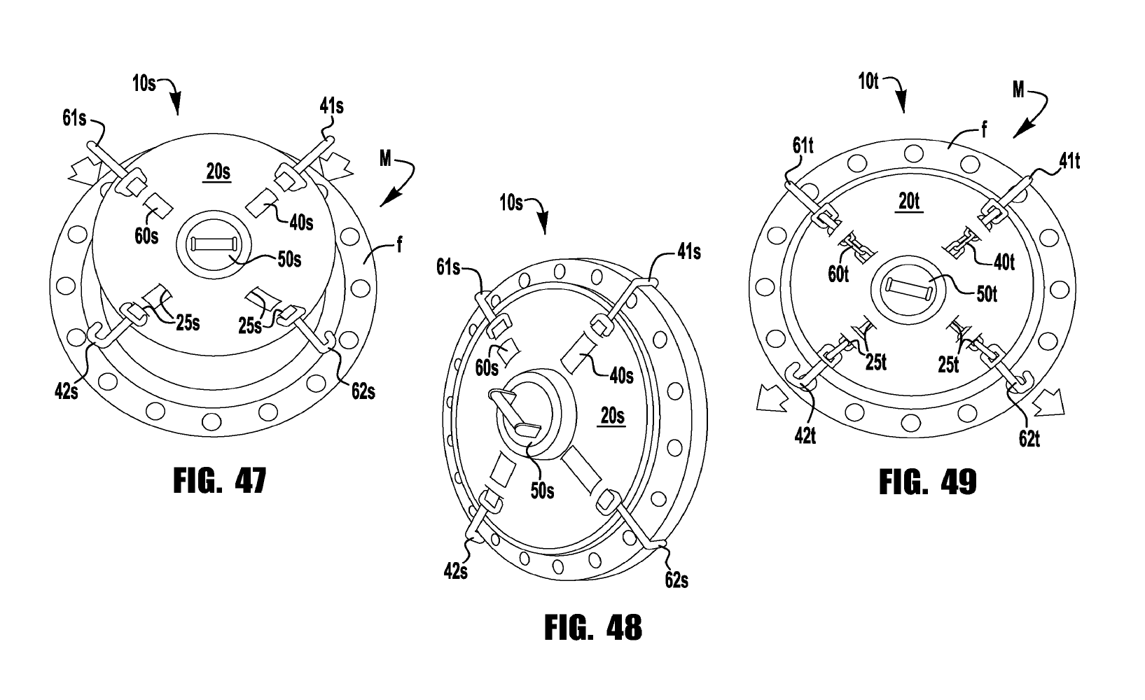

FIGS. 47-49 illustrate exemplary safety covers 10s, 10t including central covering portions 20s, 20t and first and second adjustable straps 40s, 60s, 40t, 60t threaded through openings 25s, 25t in the central covering portion. As shown, the straps 40s, 60s, 40t, 60t may be oriented in an X-shaped configuration. Each of the straps includes first and second hooks 41s, 42s, 61s, 62s, 41t, 42t, 61t, 62t sized to fit over an outer edge of the flange f. As shown, intermediate portions of the straps 40s, 60s, 40t, 60t may be retracted or extended by a rotatable adjustment handle 50s, 50t to lengthen or shorten the straps to provide secure gripping engagement of the hooks on the flange f. While many different adjustment handle arrangements may be used to lengthen or shorten the straps, in one embodiment, the adjustment handle includes a spool mechanism that winds and unwinds the straps when the handle is rotated. The handle may, but need not, be provided with a lockout mechanism (not shown).

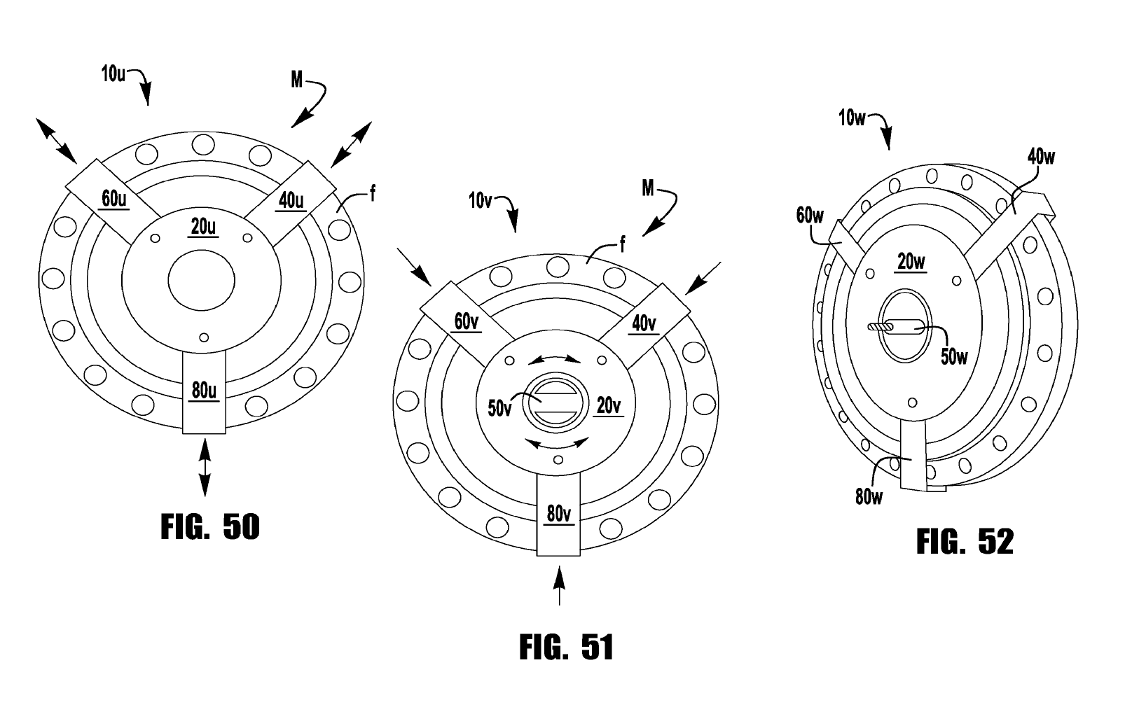

In other embodiments, one or more adjustable hook ended arms (e.g., plates, rods, or other rigid members) may be assembled with a central covering portion to attach to the outer edges of a flange or other enlarged end feature. FIG. 50 illustrates an exemplary cover assembly 10u including a central covering portion 20u and adjustable hook ended arms 40u, 60u, 80u that are slideable radially outward to extend over the flange f and slideable inward to provide secure gripping engagement of the hooks on the flange f. A detent, press fit, or locking engagement may be provided between the covering portion 20u and the arms 40u, 60u, 80u to hold the arms in a selected flange gripping position. FIGS. 51 and 52 illustrate exemplary cover assemblies 10v, 10w including central covering portions 20v, 20w and adjustable hook ended arms 40v, 60v, 80v, 40w, 60w, 80w that are adjustable outward to extend over the flange f and inward to provide secure gripping engagement of the hooks on the flange f, by rotation of an adjustment handle 50v, 50w. Many different adjustment handle arrangements may be used to adjust the arms, including, for example, gear and camming slot arrangement.

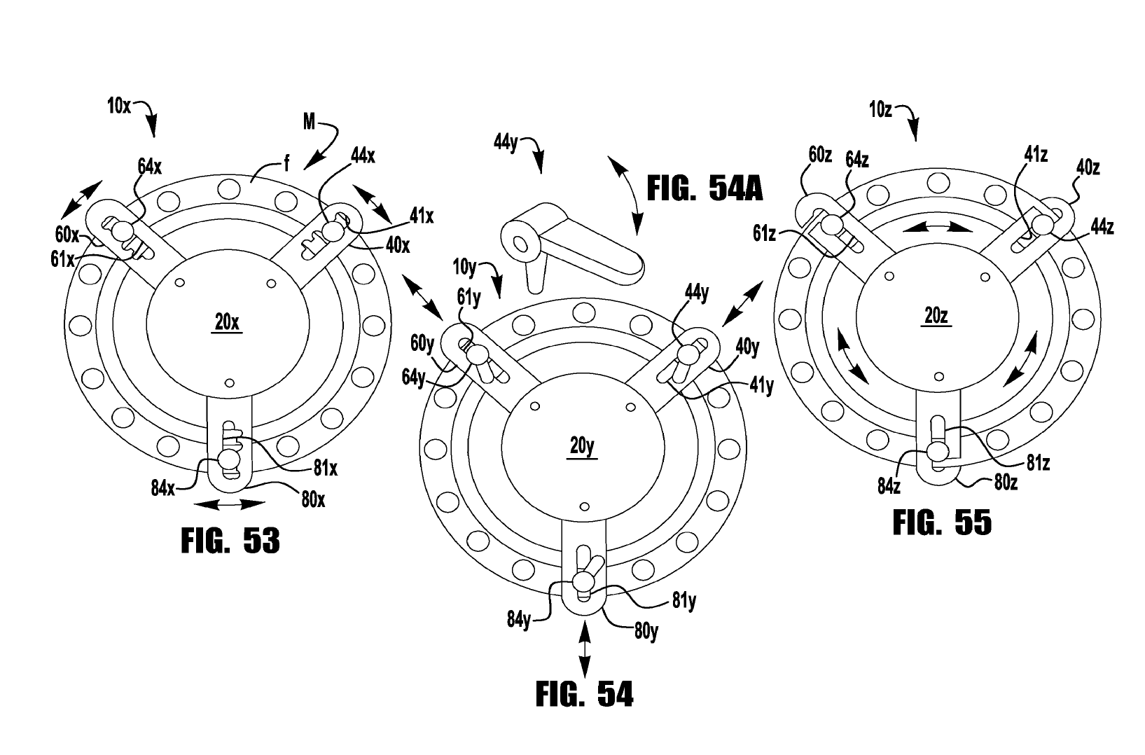

In other embodiments, flange engaging members of a cover assembly may use the holes in the flange to secure a central covering portion over the access opening. For example, one or more outer flange engaging members may include apertures that align with the flange mounting holes to receive fasteners (e.g., bolts, quick-connect clamping fasteners, zip-ties, padlock shackles, etc.) through the aligned apertures and flange mounting holes. In one embodiment, adjustable (e.g., slideable and/or pivotable) arms assembled with the central covering portion may include radially extending slots for adjustable attachment of the arms to the flange mounting holes. FIG. 53 illustrates an exemplary cover assembly 10x including a central covering portion 20x and adjustable arms 40x, 60x, 80x that are slideable and/or pivotable (e.g., about axes parallel to a central axis of the covering portion 20x) to align radially extending toothed slots 41x, 61x, 81x with mounting holes in the flange f, for attachment by mounting fasteners 44x, 64x, 84x. The teeth in the slots may impede sliding movement of the fasteners within the slots once the cover has been secured. FIG. 54 illustrates an exemplary cover assembly 10y including a central covering portion 20y and adjustable arms 40y, 60y, 80y that are slideable and/or pivotable to align radially extending slots 41y, 61y, 81y with mounting holes in the flange f, for attachment by clamping quick-connect fasteners 44y, 64y, 84y. FIG. 55 illustrates an exemplary cover assembly 10z including a central covering portion 20z and adjustable arms 40z, 60z, 80z that are slideable and/or pivotable to align radially extending notched slots 41z, 61z, 81z with mounting holes in the flange f, for attachment by mounting fasteners 44z, 64z, 84z. The notches in the slots allow for attachment of the arms to the flange f without removing the fasteners from the flange mounting holes.

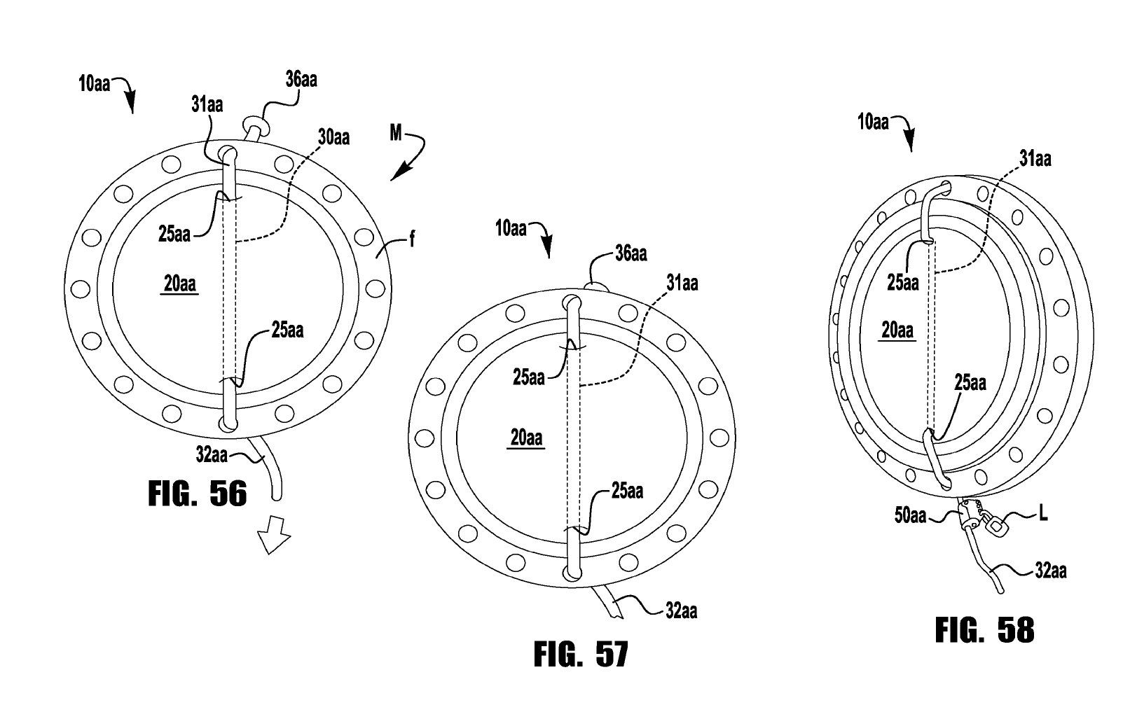

In other embodiments, the flange mounting holes of a flange may receive one or more tie-downs or tethers to secure a cover over the access opening. FIGS. 56-58 illustrate an exemplary cover assembly 10aa including a central covering portion 20aa and a securing cable 30aa assembled with the covering portion (e.g., threaded through openings 25aa in the covering portion). The securing cable 30aa includes an enlarged stopper 36aa affixed to a first end 31aa of the cable. To secure the cover 10aa to the access opening M, the second end 32aa of the cable is threaded through opposed flange mounting holes, with the stopper 36aa anchoring the first end of the cable to the flange. The cable 30aa may be secured in the tightened condition by securing a cable locking arrangement 50aa to the second flexible member ends 32aa. While any suitable cable locking arrangement may be used, in an exemplary embodiment, an adjustable cable lockout model no. S806, manufactured by Master Lock, may be utilized. The exemplary cable locking arrangement 50aa may be secured in a cable clamping condition by securing one or more lock members L (e.g. a padlock, zip-tie, or other such locking device) through aligned lock apertures in the cable lockout device 50aa. To remove the cover 10aa from the access opening M, the locking member L is removed from the aligned apertures of the cable lockout device 50aa, the cable lockout device is loosened or disassembled from the cable end 32aa, and the cable 30aa is withdrawn from the flange mounting holes.

In still other embodiments, a safety cover may include one or more bore engaging members to secure the cover to the access opening, instead of or in addition to flange engaging members (e.g., one or more of the exemplary flange engaging members described above). These covers may be used with access openings that do not include outer flanges. The bore engaging members may be positioned to engage or interlock with an internal wall, lip or shoulder in the bore to prevent unintentional and/or unauthorized withdrawal of the cover. Alternatively, the bore engaging members may extend into gripping or friction engagement with an internal surface of the bore to prevent unintentional and/or unauthorized withdrawal of the cover.

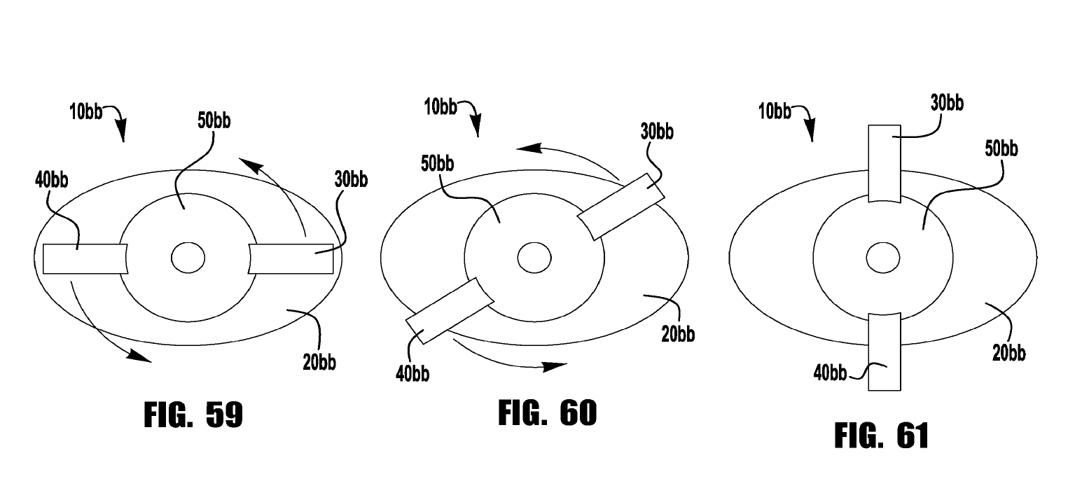

FIGS. 59-61 illustrate an exemplary cover assembly 10bb for an oval shaped access opening, including a central covering portion 20bb and rotatable bore engaging arms 30bb, 40bb extending from a rotatable dial or handle 50bb between a cover releasing position (FIG. 59) and a cover securing position (FIG. 61). The arms 30bb, 40bb may be compressible (e.g., including a compressible material or spring-loaded plungers) to accommodate variations in the bore and/or to prevent marring of the bore.

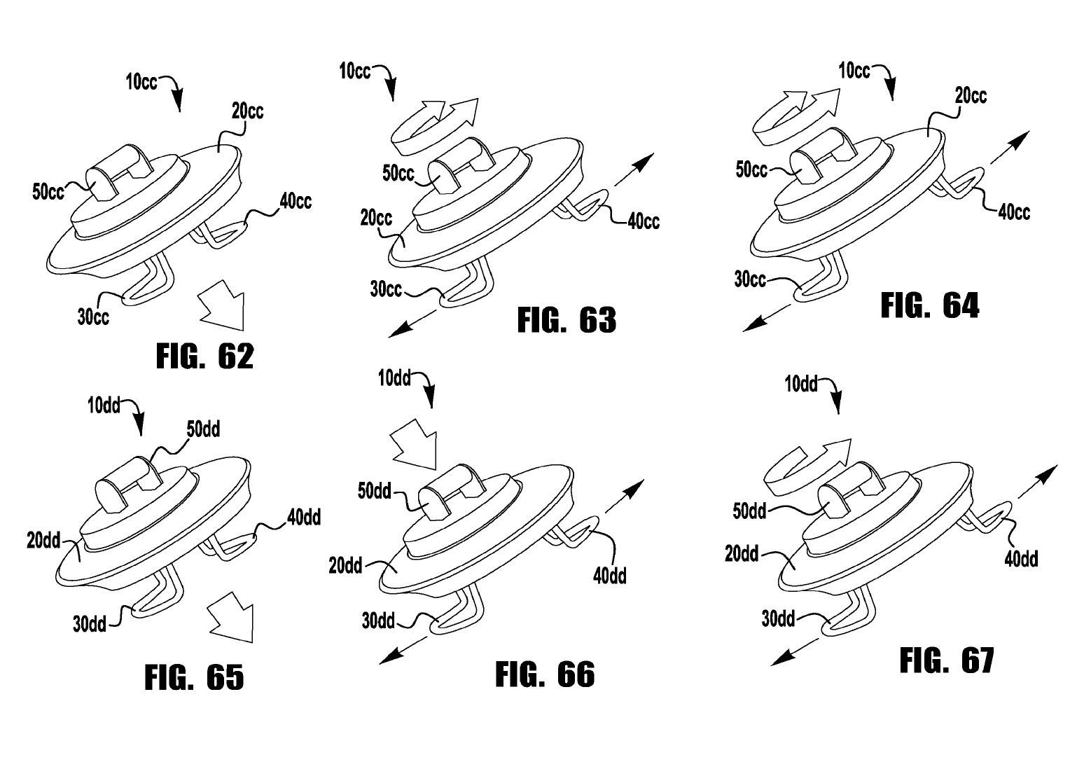

FIGS. 62-67 illustrate exemplary cover assemblies 10cc, 10dd including central covering portions 20cc, 20dd and bore engaging arms 30cc, 40cc, 30dd, 40dd radially slideable from an inner bore releasing position (FIGS. 62, 65) to an outer bore engaging position (FIGS. 64, 67) by rotation of central adjustment handles 50cc, 50dd (for example, by a gear-driven or camming mechanism). As shown in FIG. 66, the adjustment handle 50dd may additionally or alternatively be pushed downward to extend the arms 30dd, 40dd.

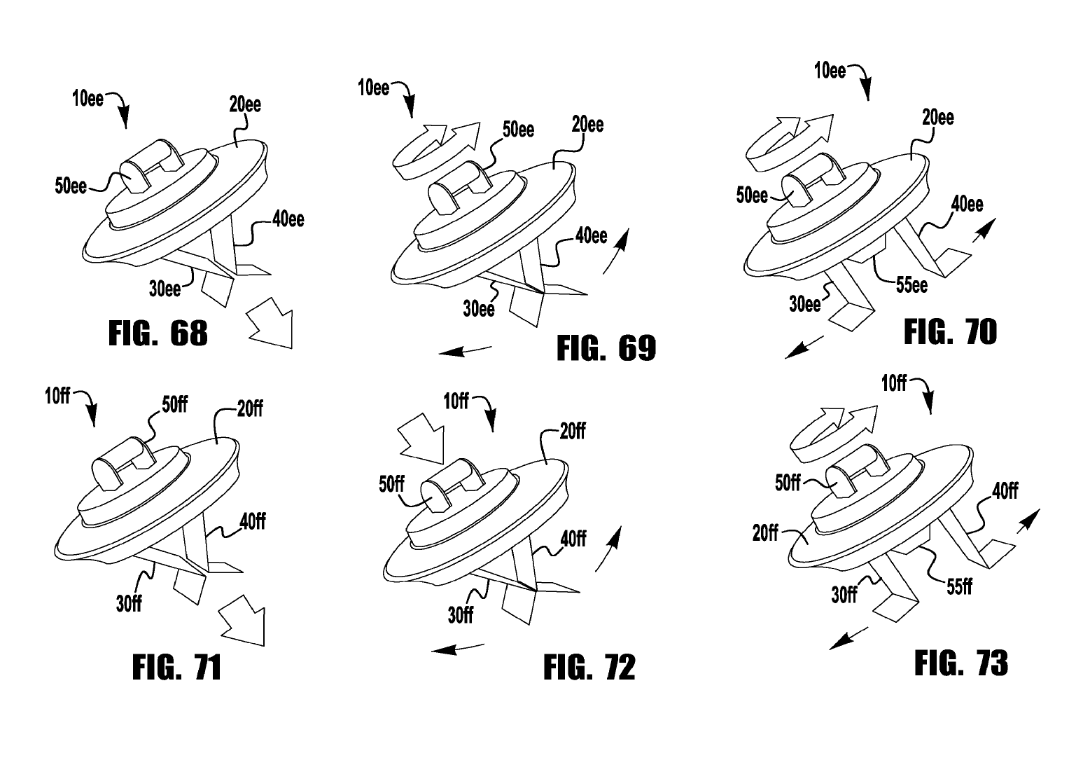

FIGS. 68-73 illustrate exemplary cover assemblies 10ee, 10ff including central covering portions 20ee, 20ff and bore engaging arms 30ee, 40ff, 30ee, 40ff pivotable (e.g., about axes parallel to a planar surface of the covering portion 20ee, 20ff) from an inner bore releasing position (FIGS. 68, 71) to an outer bore engaging position (FIGS. 70, 73) by rotation of central adjustment handles 50ee, 50ff, which rotate camming members 55ee, 55ff between the arms to force the arms outward. As shown in FIG. 72, the adjustment handle 50ff may additionally or alternatively be pushed downward to extend the camming member 55ff between the arms 30ee, 40ff.

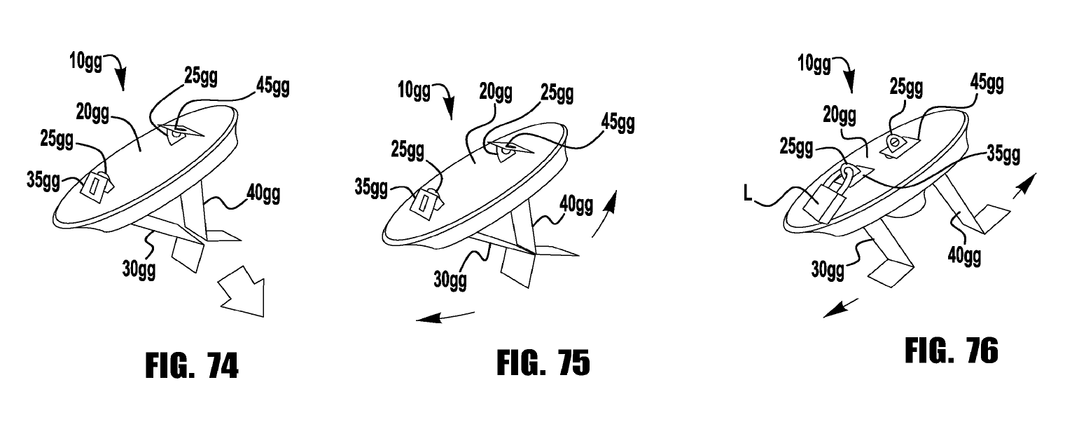

FIGS. 74-76 illustrate an exemplary cover assembly 10gg including a central covering portion 20gg and bore engaging arms 30gg, 40gg pivotable (e.g., about axes parallel to a planar surface of the covering portion 20gg) from an inner bore releasing position (FIG. 74) to an outer bore engaging position (FIG. 76). In the bore engaging position, hasps 25gg extending from an upper surface of the covering portion 20gg extend through slots in flanged upper ends 35gg, 45gg of the arms 30gg, 40gg. Insertion of locking members L through the hasps 25gg secures the arms 30gg, 40gg in the bore engaging position.

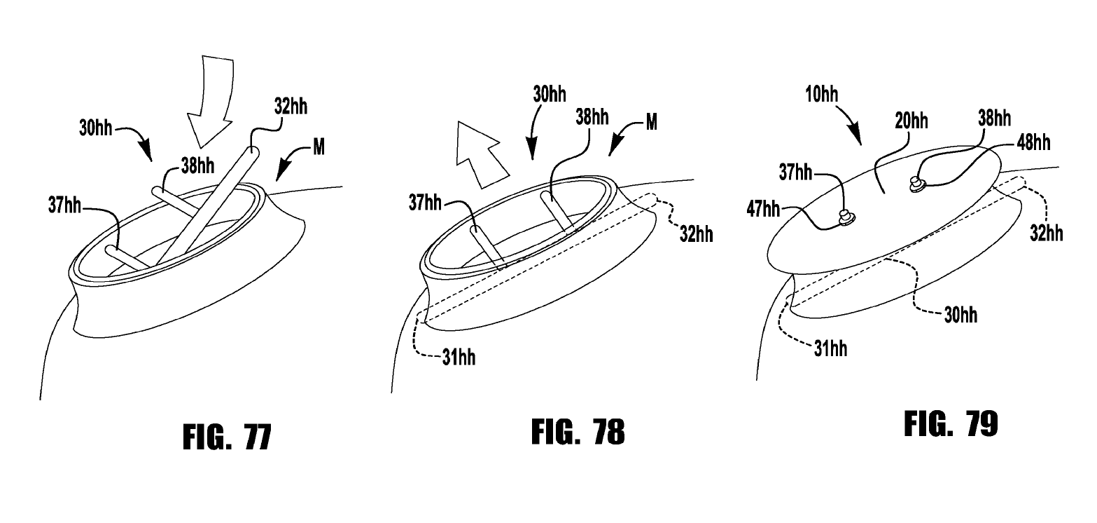

FIGS. 77-79 illustrate an exemplary cover assembly 10hh including a central covering portion 20hh and a bore engaging frame 30hh including laterally extending arms 31hh, 32hh and one or more axially extending sterns 37hh, 38hh for installation through mounting holes 27hh, 28hh in the covering portion 20hh. To secure the cover 10hh to the access opening M, the frame 30hh is inserted into the bore and oriented to engage the arms 31hh, 32hh with an internal shoulder in the bore. The stems 37hh, 38hh are inserted through the covering portion mounting holes 27hh, 28hh, and mounting nuts 47hh, 48hh or other such fasteners are assembled with threaded end portions of the stems 37hh, 38hh. In other embodiments, the cover member may be attached to the one or more stems of the frame member using other suitable arrangements, including, for example, clamps, adhesive, locking brackets, or press fit engagement.

The cover assembly embodiments of FIGS. 62-79 shown bore engaging arms 30cc-hh, 40cc-hh having a substantially L-shaped profile shaped to extend into a bore and interlock with an internal wall, lip, or shoulder in the bore. In other embodiments, one or more bore engaging arms (e.g., the bore engaging arms described in any of the exemplary embodiments of FIGS. 59-83) may be configured to extend radially outward for gripping or frictional engagement with an internal surface of the bore. To facilitate a gripping or frictional engagement, at least an end portion of the arms may be provided in a soft or compressible material, and an arm adjusting mechanism may be provided with a detent, camming, or locking feature to hold the arms in gripping engagement with the bore. The arms may be provided in any suitable radially extending shape.

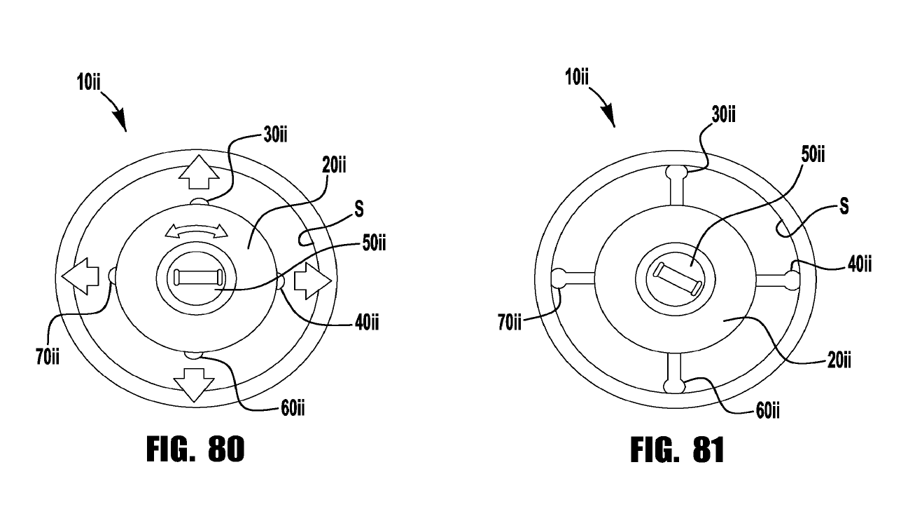

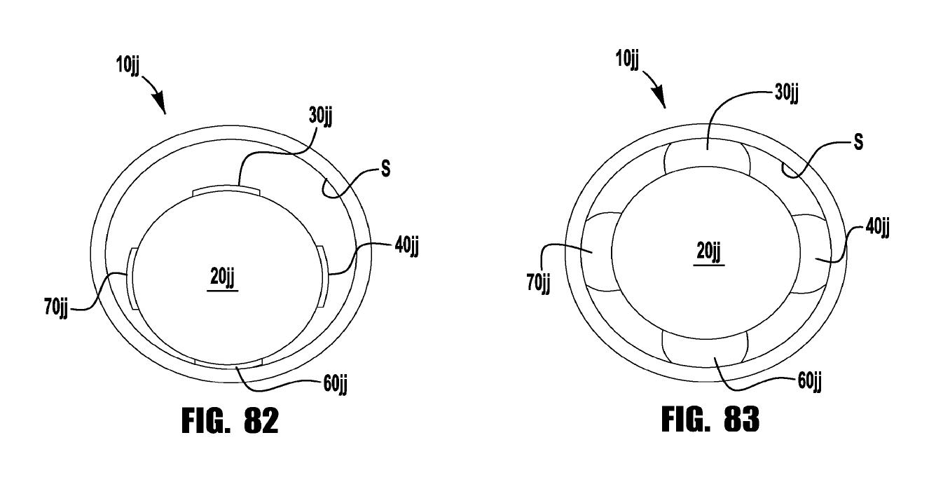

FIGS. 80 and 81 illustrate an exemplary cover assembly 10ii including a central covering portion 20ii and bore engaging arms 30ii, 40ii, 60ii, 70ii extendable from an inner bore releasing position (FIG. 80) to an outer bore engaging position (FIG. 81) by rotation of a central adjustment handle ii (for example, by a gear-driven or camming mechanism). In the bore engaging position, the arms 30ii, 40ii, 60ii, 70ii exert a gripping or frictional force against an internal surface s of the bore.

FIGS. 82 and 83 illustrate an exemplary cover assembly 10jj including a central covering portion 20jj and bore engaging inflatable arms 30jj, 40jj, 60jj, 70jj expandable from an inner bore releasing position (FIG. 82) to an outer bore engaging position (FIG. 83) by inflation (e.g., by a mechanical or pneumatic pump). In the bore engaging position, the arms 30jj, 40jj, 60jj, 70jj exert a gripping or frictional force against an internal surface s of the bore. The arms may be provided as separate inflatable members, or as extensions of a single inflatable member. Other shapes of inflatable members may additionally or alternatively be used (e.g., circular or donut shaped for uniform engagement around the circumference of the cover).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A cover assembly for restricting access to an access opening, the cover assembly comprising:
a cover member including a central covering portion surrounded by an outer peripheral collar portion defining a passage, and a tab affixed to the collar portion, the tab including at least one tab aperture; and
a flexible member extending through the passage and having a first end extending outward of the passage and including at least one flexible member aperture, and a second end secured to the collar portion;
wherein when the first end of the flexible member is pulled, the collar portion of the cover member is constricted, and one of the at least one flexible member apertures is aligned with one of the at least one tab apertures to receive a locking member therethrough, thereby securing the collar portion in a constricted condition.

2. The cover assembly of claim 1, wherein the tab comprises a sleeve secured to the collar portion at a passage opening of the collar portion, such that the second end of the flexible member extends through the sleeve.

3. The cover assembly of claim 1, wherein the second end of the flexible member is secured to the collar portion within the passage.

4. The cover assembly of claim 1, wherein the tab is affixed to an outer surface of the collar portion.

5. The cover assembly of claim 1, wherein the flexible member comprises a strap shaped member.

6. The cover assembly of claim 1, wherein the flexible member comprises a chain, wherein one or more links in the chain define the at least one flexible member aperture.

7. The cover assembly of claim 1, wherein the collar portion includes a series of holes defining the passage through which the flexible member is laced.

8. The cover assembly of claim 1, wherein the collar portion includes a webbing material defining the passage through which the flexible member is laced.

9. The cover assembly of claim 1, wherein the collar portion includes an outer peripheral sheath defining the passage.

10. The cover assembly of claim 1, wherein the central covering portion comprises a flexible sheet.

11. A method for restricting access to an access opening surrounded by a flange, the method comprising:
placing a cover member over the access opening, such that a central covering portion of the cover member covers the access opening, and an outer peripheral collar portion of the cover member extends over the flange;
pulling a first end of a flexible member extending outward of a passage in the collar portion to constrict the collar portion against the flange, the flexible member having a second end secured to the collar portion;
aligning an aperture in the first end of the flexible member with an aperture in a tab affixed to the collar portion; and
inserting a locking member through the aligned apertures to secure the collar portion in a constricted condition.

12. The method of claim 11, wherein the tab comprises a sleeve secured to the collar portion at a passage opening of the collar portion, such that the second end of the flexible member extends through the sleeve.

13. The method of claim 11, wherein the second end of the flexible member is secured to the collar portion within the passage.

14. The method of claim 11, wherein the tab is affixed to an outer surface of the collar portion.

15. The method of claim 11, wherein the flexible member comprises a strap shaped member.

16. The method of claim 11, wherein the central covering portion comprises a flexible sheet.

17. A cover assembly for restricting access to an access opening, the cover assembly comprising:
a cover member including a central covering portion surrounded by an outer peripheral collar portion defining a passage; and
a flexible member extending through the passage and having first and second ends extending outward of the passage through first and second openings in the collar portion, the first end including at least one flexible member aperture, and the second end including a buckle portion having a tine with a lock aperture therethrough;
wherein when the first end of the flexible member is pulled and the tine is inserted through one of the at least one flexible member apertures, the collar portion of the cover member is constricted, such that insertion of a locking member through the lock aperture secures the collar portion in a constricted condition.

18. The cover assembly of claim 17, wherein the flexible member comprises a strap shaped member.

19. The cover assembly of claim 17, wherein the collar portion includes a series of holes defining the passage through which the flexible member is laced.

20. The cover assembly of claim 17, wherein the central covering portion comprises a flexible sheet.

21. A method for restricting access to an access opening surrounded by a flange, the method comprising:
placing a cover member over the access opening, such that a central covering portion of the cover member covers the access opening, and an outer peripheral collar portion of the cover member extends over the flange;
pulling first and second ends of a flexible member extending outward of a passage in the collar portion to constrict the collar portion against the flange; and
operating a flexible member gripping mechanism assembled with the first end of the flexible member to grip against a selected portion of the second end of the flexible member, thereby securing the collar portion in a constricted condition.

22. The method of claim 21, wherein the second end of the flexible member comprises a cable shaped portion.

23. The method of claim 22, wherein the flexible member gripping mechanism comprises a cable lockout device.

24. The method of claim 21, wherein the second end of the flexible member comprises a strap shaped portion.

25. The method of claim 24, wherein the flexible member gripping mechanism comprises a ratchet tie down device.

26. The method of claim 21, further comprising locking the flexible member gripping mechanism in a gripping condition.

27. The method of claim 26, wherein locking the flexible member gripping mechanism in the gripping condition comprises inserting a locking member through at least one lock aperture in the flexible member gripping mechanism.

28. The method of claim 21, wherein the central covering portion comprises a flexible sheet.

29. A cover assembly for restricting access to an access opening, the cover assembly comprising:
a cover member including a central covering portion surrounded by an outer peripheral collar portion; and
at least one strap securable to first and second opposed portions of the collar portion;
wherein when the collar portion of the cover member is installed over an outer flange portion of a flanged access opening, the at least one strap is adjustable to secure the cover member to the flanged access opening.

30. The cover assembly of claim 29, wherein the at least one strap comprises an elastic material.

31. The cover assembly of claim 29, wherein the at least one strap comprises first and second straps.

32. The cover assembly of claim 31, wherein the first and second straps are configured to extend on opposite sides of the access opening when the cover assembly is installed on the flanged access opening.

33. The cover assembly of claim 31, wherein the first and second straps are oriented in an X-shaped configuration.

34. The cover assembly of claim 29, wherein the at least one strap is permanently affixed to the first portion of the collar portion and selectively attachable to the second portion of the collar portion.

35. The cover assembly of claim 29, wherein the at least one strap includes first and second hook portions sized to fit over an outer flange portion of the flanged access opening.

36. The cover assembly of claim 29, wherein the at least one strap includes an adjustment mechanism for adjusting an effective length of the at least one strap.

37. The cover assembly of claim 36, wherein the adjustment mechanism includes at least one of a buckle, a cable lockout device, a ratchet tie down device, and a rotatable spool mechanism.

38. A method for restricting access to a flanged access opening, the method comprising:
placing a cover member over the access opening, such that a central covering portion of the cover member covers the access opening and a collar portion aligns with an outer flange portion of the access opening;
securing at least one strap to first and second opposed portions of the collar portion; and
adjusting the at least one strap to secure the cover member to the flanged access opening.

39. A cover assembly for restricting access to an access opening including an end portion, the cover assembly comprising:
a cover member including a central covering portion; and
a plurality of rigid arms assembled with the cover member and adjustable between a lockout position for engagement with the end portion and a release position for disengagement from the end portion.

40. The cover assembly of claim 39, wherein the plurality of rigid arms are radially slideable between the lockout position and the release position.

41. The cover assembly of claim 39, wherein the plurality of rigid arms are pivotable between the lockout position and the release position.

42. The cover assembly of claim 41, wherein the plurality of rigid arms are pivotable with respect to at least one axis that is parallel to a central axis of the central covering portion.

43. The cover assembly of claim 41, wherein the plurality of rigid arms are pivotable with respect to at least one axis that is parallel to a planar surface of the central covering portion.

44. The cover assembly of claim 39, wherein the plurality of rigid arms are configured to engage outer peripheral surfaces of the end portion in the lockout position.

45. The cover assembly of claim 39, wherein the plurality of rigid arms are configured to engage inner peripheral surfaces of the end portion in the lockout position.

46. A method for restricting access to access opening including an end portion, the method comprising:
placing a cover member over the access opening, such that a central covering portion of the cover member covers the access opening;
adjusting a plurality of rigid arms assembled with the cover member from a releasing position in which the plurality of rigid arms are disengaged from the end portion of the access opening to a lockout position in which the plurality of rigid arms are engaged with the end portion of the access opening to secure the cover member to the access opening.

47. A method of restricting access to an access opening having an end portion with a first diameter and an inner portion with a second diameter greater than the first diameter, the inner portion being separated from the end portion by a shoulder, the method comprising:
inserting a frame member into the inner portion of the access opening, the frame member having first and second laterally extending arms together defining a length greater than the first diameter, and at least one stem extending transverse to the first and second arms;
orienting the frame member such that the at least one stem extends toward the end portion of the access opening;
placing a cover member over the access opening, such that a central covering portion of the cover member covers the access opening; and
securing the cover member to the at least one stem.

48. The method of claim 47, wherein securing the cover member to the at least one stem comprises receiving the at least one stem through a corresponding mounting hole in the cover member.

49. A cover assembly for restricting access to a flanged access opening including a flange having a ring of mounting holes, the cover assembly comprising:
a cover member including a central covering portion; and
a plurality of rigid arms assembled with the cover member, with each of the plurality of rigid arms being adjustable to align at least one mounting aperture on the rigid arm with a corresponding mounting hole of the flanged access opening for mounting the plurality of rigid arms to the flange.

50. The cover assembly of claim 49, wherein the rigid arms are slideable in a radial direction.

51. The cover assembly of claim 49, wherein the rigid arms are pivotable with respect to the cover member.

52. The cover assembly of claim 49, wherein the at least one mounting aperture on each rigid arm includes a radially extending slot.

53. The cover assembly of claim 49, wherein the at least one mounting aperture on each rigid arm includes an exterior notch.

54. A method for restricting access to a flanged access opening including a flange having a ring of mounting holes, the method comprising:
placing a cover member over the access opening, such that a central covering portion of the cover member covers the access opening;
adjusting a plurality of rigid arms assembled with the cover member such that a mounting aperture on each of the plurality of rigid arms aligns with a corresponding one of the mounting holes in the flange; and
installing a fastener through each of the aligned mounting apertures and mounting holes to secure the cover member over the access opening.
